(19) United States
(12) Patent Application Publication
(10) Pub. No.: US 2023/0334500 A1
(43) Pub. Date: Oct. 19, 2023

(54) RISK RESERVES

(71) Applicant: STRIPE, INC., South San Francisco, CA (US)

(72) Inventors: Rishabh Jain, San Francisco, CA (US); Arnav Kumar, London (GB); Ryan McAfee, Atlanta, GA (US); Siva Vasanth, Redmond, WA (US)

(21) Appl. No.: 17/882,471

(22) Filed: Aug. 5, 2022

Related U.S. Application Data
(63) Continuation-in-part of application No. 17/723,126, filed on Apr. 18, 2022.
Application No. 17/723,126 is a continuation-in-part of application No. 17/723,190, filed on Apr. 18, 2022.

(51) Int. Cl. G06Q 20/40; G06Q 20/38

(52) U.S. Cl. CPC G06Q 20/405; G06Q 20/389

(57) ABSTRACT

Methods and apparatuses are disclosed for performing money movement transactions with a reserved amount retained from a payout. In some embodiments, the method comprises intercepting a plurality of transactions received via network communications, where each transaction of the plurality of transactions specifying a money movement and having a book keeping system of a commerce platform as a destination. The method also includes, for each intercepted transaction, performing a policy evaluation process that includes determining if a fund flow transformation rule applies to each intercepted transaction based on attributes associated with each intercepted transaction and modifying at least one intercepted transaction by changing the money movement according to the fund flow transformation rule into a plurality of money movements with specified balances to complete each money movement of the plurality of money movements, with one money movement to reserve a portion of a transaction amount.

### PRIORITY

The present patent application is a continuation-in-part of, and claims priority to, U.S. patent application Ser. No. 17/723,126, titled “POLICY ORCHESTRATOR,” filed on Apr. 18, 2022, and U.S. patent application Ser. No. 17/723,190, titled “POLICY ENGINE,” filed on Apr. 18, 2022, both of which are incorporated in their entirety by reference.

### FIELD

Embodiments of the present disclosure relate to the field of processing of electronic transactions involving money movements; more particularly, embodiments of the present disclosure relate to handling money movements associated with electronic transactions in which a reserve amount (e.g., a risk reserve) is held from the transaction amount.

### BACKGROUND

Some merchants choose to minimize their investment by working with third parties to handle all their payment needs. These third parties are often referred to as payment processors. In these cases, the merchants redirect their customers to the third party, which is responsible for capturing the payment information and processing the transaction. The payment processor will later pay the merchants for successful transactions under previously agreed upon terms.

As part of paying merchants, the payment processors move money today on an application layer. These movements may comprise a number of different fund flows involving account balances of multiple parties. These fund flows may be between account balances of parties within control of the payment processor or from an account within control of the payment processor to an external account of another, or vice versa.

As the number of fund flows grows large, the money movements may become more complex. Further complicating the situation is that many fund flows are subject to external regulations (e.g., banking regulations). Merchants and other customers of the payment processor want the payment processor to build more and more fund flows and/or augment existing ones without thinking about the inner workings of payment networks (e.g., the Global Payment and Treasury Network (GPTN)) and without worrying about external regulations.

However, while supporting merchants, payment processor recognize that certain industries are riskier that others, and even good merchants in these industries can be risky. Additionally, as new merchants want to be onboarded by the payment processor to have their payments handled, many of these merchant do not have a track record and therefore pose a risk to the payment processors. To compensate for the added risk, some payment processors reserve a portion of funds of its merchant's transactions in case a problem arises with the merchant and the payment processors are not able to receive their own payments or subject their own capital to loss.

In some situations, payment processors set a reserve amount by looking back at a merchant's positive volume at payout time to determine an amount to take from a current payout. When subsequently releasing the funds, the payment processors also determine the amount to release from reserve if the merchant's balance is negative at payout time. In this case, because reserves are calculated at payout time and the payout amount is used as part of the calculation, the payment process is not able to give a completely truthful, deterministic expectation to the merchant of exactly what their reserved amount will be and what will be paid out. Furthermore, because positive transfers and payout amounts are aggregated to determine an amount to reserve, there's no way to see from which transactions a reserve comes. Reserving based on the gross volume without accounting for fees causes merchant confusion because a reserve in an ideal situation can actually be more than the money even available in the merchant's balance. Thus, from a merchant perspective, currently handling of reserves may not produce a desired customer experience.

### SUMMARY

Methods and apparatuses are disclosed for performing money movement transactions with a reserved amount retained from a payout. In some embodiments, the method comprises intercepting a plurality of transactions received via network communications, where each transaction of the plurality of transactions specifying a money movement and having a book keeping system of a commerce platform as a destination. The method also includes, for each intercepted transaction, performing a policy evaluation process that includes determining if a fund flow transformation rule applies to each intercepted transaction based on attributes associated with each intercepted transaction, in response to determining a fund flow transformation rule applies, modifying at least one intercepted transaction by changing the money movement according to the fund flow transformation rule into a plurality of money movements with specified balances to complete each money movement of the plurality of money movements, wherein one of the plurality of money movements is to reserve a portion of a transaction amount of at least one intercepted transaction to a reserve balance for payout after occurrence of an event, and sending each intercepted transaction, including the at least one intercepted transaction with the plurality of money movements, to the book keeping system of a commerce platform.

### BRIEF DESCRIPTION OF THE DRAWINGS

The present disclosure will be understood more fully from the detailed description given below and from the accompanying drawings of various embodiments of the disclosure, which, however, should not be taken to limit the disclosure to the specific embodiments, but are for explanation and understanding only.

FIG. 1 is a block diagram of an example of a network environment with commerce platform.

FIG. 2 illustrates a portion of a commerce platform that processing money movement transactions as part of book keeping operations.

FIG. 3 illustrates some embodiments of a policy engine that performs a policy evaluation process on money movement transactions (e.g., money movement requests).

FIG. 4 illustrates one embodiment of a gating rule interface.

FIG. 5 illustrates one embodiment of a fund flow transformation interface.

FIG. 6 illustrates an example of a transformation rule splitting entries.

FIG. 7 illustrates one embodiment of an event analysis interface.

FIG. 8 illustrates one embodiment of propagation interfaces.

FIGS. 9 and 10 illustrate examples of tag propagation.

FIG. 11 illustrates one embodiment of a balance invariant resolution interface.

FIG. 12A illustrates a sequence diagram of a call flow between various parts of some embodiments of a payment processing system.

FIG. 12B illustrates an example of a destination charge being handled by some embodiments of an orchestrator module.

FIG. 13 is a data flow diagram of some embodiments of processing logic for handling reserve balances.

FIG. 14 is a flow diagram of one embodiment of a process for processing money movement transactions.

FIG. 15 is a data flow diagram of one embodiment of a process for orchestrating money movement transactions.

FIG. 16 is a data flow diagram of one embodiment of a process for processing money movement transactions that involve risk reserves.

FIG. 17 is a block diagram of one embodiment of a computer system that may be used to support the systems and operations discussed herein.

### DETAILED DESCRIPTION

In the following description, numerous details are set forth to provide a more thorough explanation of the present disclosure. It will be apparent, however, to one skilled in the art, that the present disclosure may be practiced without these specific details. In other instances, well-known structures and devices are shown in block diagram form, rather than in detail, to avoid obscuring the present disclosure.

Techniques are disclosed herein for processing transactions in an ecommerce platform. In some embodiments, the transactions involve money movements and the techniques disclosed herein involve the use of a policy engine in the ecommerce platform that completes the transactions to a money movement platform, or the book keeping layer/system, of the ecommerce platform. In some embodiments, the policy engine receives all logical booking rights to the book keeping system. Such a book keeping system may be responsible for handling the net cash flow for the ecommerce platform. Note that for purposes herein, the book keeping system may include multiple computing systems, such as, for example, servers and/or personal computer systems.

In some embodiments, the policy engine uses an orchestrator in order to provide a central point for processing money movement transactions. In some embodiments, the orchestrator orchestrates the money movement transactions through the system. In some embodiments, the orchestrator validates or authorizes money movement transactions prior to the time that they are to be committed. If the orchestrator determines that the money movement is valid, then the money movement is allowed to proceed and ultimately be sent to bookkeeping system. In some embodiments, the determination of whether money movement is valid is based on determination of whether the money movement is legal or not.

In some embodiments, the policy engine processes transactions with money movements by performing fund flow transformations. These fund flow transformations may be used to change the flow of funds specified by the money movement. The change may be based on application of a policy by the policy engine. The application of the policy may involve applying a constraint, referred to herein as a system invariant, to the money movement with the fund flow transformations being implemented as rules. For example, if the policy indicates that a portion of a pay-in fund flow should be reserved (e.g., 10% of the money movement or fund flow) due to a risk associated with the transaction, the constraint may indicate that the portion of the fund flow, representing a risk reserve, should be made to a risk reserve balance as part of completing the transaction. In such a case, the policy engine transforms the money movement associated with the transaction to include a flow of funds into the risk reserve balance. In some embodiment, the transformation rules allow money movement from net credited balances of a customer (e.g., merchant) to their reserve balance. Other fund flow transformation rules, for example, allow the application of constraints to enable the use of pre-funding balances for use in covering items such as, for example, disputes and refunds. In such cases, the fund flow transformation rule can apply a constraint to pick the “pre funding” balance on such flows. As shown by these examples, in some embodiments, system invariants are encoded in policy through the use of fund flow transformations.

Other uses of fund flow transformation rules can specify which funds (e.g., balances) are used to fulfill a transaction. For example, in a country such as Brazil, a fund flow transformation rule can apply a policy to ensure that money is only moved through a Brazil-tagged balance. For example, when trying to satisfy a transaction through multiple tagged buckets of money, the policy engine may select one of a number of ways to complete the transaction. For example, if merchant M1 has account balances B1 and B2 that are used to move money to merchant M2, the policy engine may determine and cause the money movement to be completed using a series of linearized transfers or a set of parallelized split transfers. In the case of linearized transfers, the policy engine may specify the money movement as first moving M1[B2]→M1[B1] and then move M1[B1]→M2[B2]. In the case of parallelized splits, the policy engine may specify the money movement as moving M1[B1]→M2[B1] and M1 [B2]→M2[B2] at the same time.

In some embodiments, the policy engine uses tagging and tag propagation as part of implementing a policy. The tag propagation may propagate a tag across money movement chains associated with transactions. The use and propagation of tags may help in the traceability of funds, which is particularly important for regulators of payment processing providers and banking-related operations.

An example of a commerce platform is described below. In some embodiments, the commerce platform may include payment processing through the use of a payment processor, such as, for example, STRIPE™. After describing an example of a commerce platform, embodiments of a policy engine and transaction processing will be described in more detail.

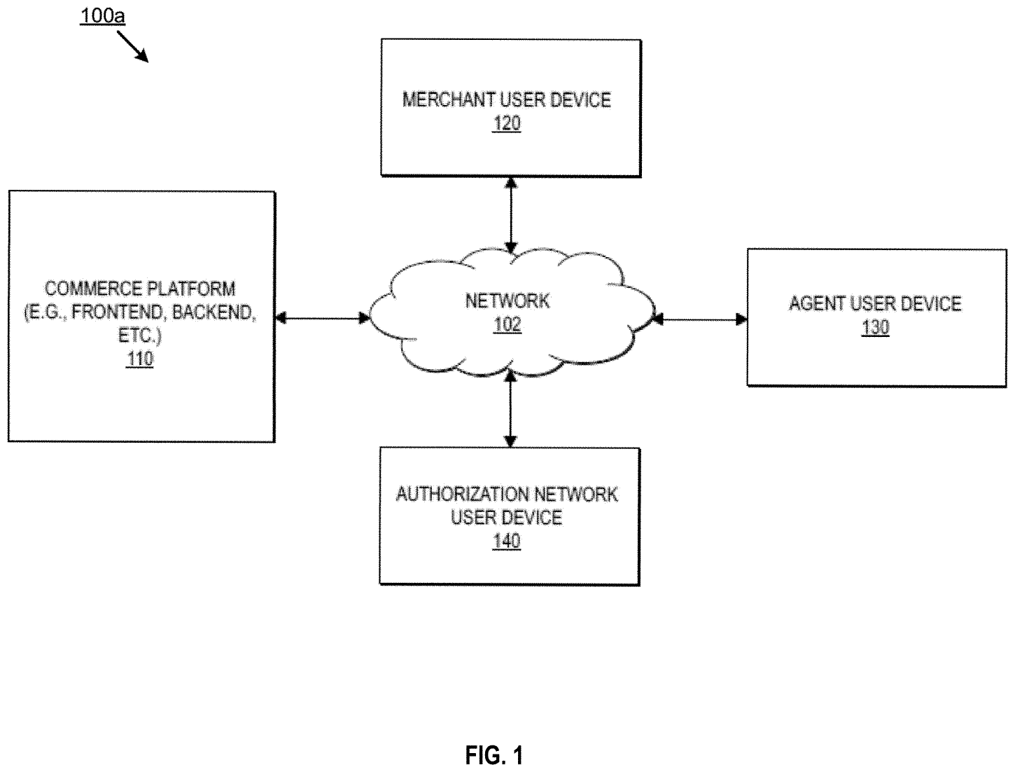

FIG. 1 is a block diagram of an example of a system 100 for a commerce platform. In one embodiment, system 100 includes a commerce platform 110, a merchant user device 120, an agent user device 130, and an authorization network user device 140. In one embodiment, user devices (e.g., devices 120, 130, and 140) may be mobile computing devices, such as a smartphone, tablet computer, smartwatch, etc., as well computer systems, such as a desktop computer system, laptop computer system, server computer systems, etc. The commerce platform 110 may also be one or more computing devices, such as one or more server computer systems, desktop computer systems, etc.

The commerce platform 110, merchant user device 120, agent user device 130, and authorization network user device 140 may be coupled to a network 102 and communicate with one another using any of the standard protocols for the exchange of information, including secure communication protocols. In one embodiment, one or more of the commerce platform 110, merchant user device 120, agent user device 130, and authorization network user device 140 may run on one Local Area Network (LAN) and may be incorporated into the same physical or logical system, or different physical or logical systems. Alternatively, the commerce platform 110, merchant user device 120, agent user device 130, and authorization network user device 140 may reside on different LANs, wide area networks, cellular telephone networks, etc. that may be coupled together via the Internet but separated by firewalls, routers, and/or other network devices. In one embodiment, commerce platform 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc. In one embodiment, commerce platform 110 provides software service, e.g., financial processing services to one or more of merchant user device 120, agent user device 130, and/or authorization network user device 140, such as managing accounts, running financial transactions, clearing transactions, performing payouts to agents, managing merchant and/or agent accounts, as well as other services typically associated with commerce platforms systems such as, for example, STRIPE™.

In some embodiments, the commerce platform includes a book keeping system or a booking layer that records financial transactions (e.g., payment processing transactions). In some embodiments, these transactions include money movements between accounts (e.g., between account balances) or involve at least one account (e.g., a payout, payments, etc.) of or controlled by a payment processor. In some embodiments, the account balances may be those of customers (e.g., merchants, users, banks, etc.) of the payment processing system, and transactions are designated or otherwise addressed to the book keeping system. In some embodiments, these transactions are sent as network communications or messages to the book keeping system over one or more network connections.

### Policy Engine Architecture

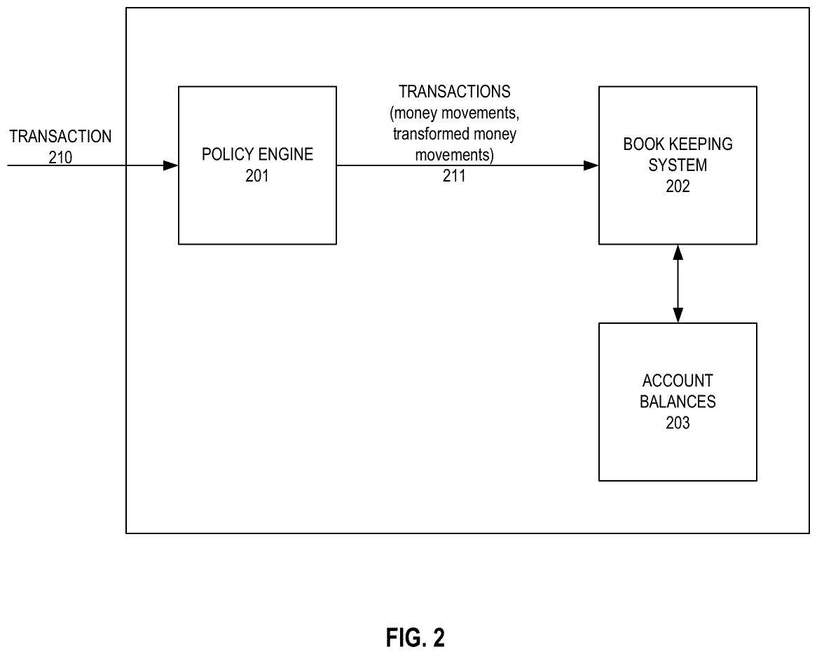

FIG. 2 illustrates a portion of a commerce platform that processes money movement transactions as part of book keeping operations. Referring to FIG. 2, commerce platform 200 includes a policy engine 201 that receives transactions 210 that involve money movements that are to occur at the book keeping system 202. Policy engine 201 enforces policies with respect to those money movements. In some embodiments, the enforcement of policies may involve mutating or changing a money movement specified in a transaction into one or more money movements that adhere to or are in line with a policy being enforced or implemented.

In some embodiments, policy engine 201 intercepts transactions and converts them to a materialized transaction for a fund flow. To that end, policy engine 201 acts as a centralized place to apply a materialized set of instructions based on policy constraints to a fund flow. In some embodiments, policy engine 201 performs this function by mapping a transaction to the set of rules that should apply, internally (e.g., system/GPTN specific rules) and/or globally (e.g., regulatory), and cross verifies if the proposed set of instructions are valid. In the case the instructions are not valid, in some embodiments, policy engine 201 tries to materialize a reasonable alternative that will satisfy both the rules and what the transaction was originally intended to do at creation.

After policy engine 201 has completed performing policy enforcement, transactions 211 are forwarded onto book keeping system 202 for completion. Note that transactions 211 may include some transactions that have money movements that were not changed by policy engine 201, while other transactions have money movements that were changed by policy engine 201.

After receiving transactions 211, book keeping system 202 uses one or more of account balances 203 to complete the transactions. Account balances 203 may include balances of customers (e.g., merchants) of a payment processor and these may include payment balances, risk reserve balances, expense payment balance, or other balances that a handler of money movements (e.g., a payment processor) may use.

In some embodiments, policy engine 201 comprises a compiling and tagging system that provides an interface to do legal money movements. In such a case, policy engine 201 receives and converts each transaction into materialized transaction for a fund flow while tagging and persisting tags into the book keeping system that are part of book keeping rights. These transactions trigger actual cash flow off these book keeping rights.

In some embodiments, policy engine 201 intercepts all book keeping rights transactions and determines which policy rules to apply to each transaction, if any. In some embodiments, this determination is made by inspecting a set of attributes to determine if a policy rule applies. These attributes can relate risk rules that apply to a merchant or other customer associated with the transaction, a purpose of money movement (top off an account, top off for future refund or dispute, transfer between two accounts of payment processor, etc.), an amount of the transaction, etc.).

If policy engine 201 determines that a policy rule applies, policy engine 201 uses transformation rules to modify, or otherwise mutate, book keeping rights based on system invariants that are encoded in policy through fund flow transformations. As such policy engine 201 applies constraints to a fraction of the fund flows associated with a transaction. In some embodiments, the constraints apply to merchants (or other customers) linked within a transaction, to how money should move for a GPTN fund flow, and/or to the account balances that are linked within a transaction. In other words, policy engine 201 performs modifications to the money movements of the transactions to enable the transaction to adhere to the policies that are applied to the transactions. For example, policy engine 201 can use one or more transformation rules to mutate a transaction by splitting a single money movement into multiple segmented money movements. Other mutations may include adding one or more different accounts (e.g., account balances) to the fund flow to implement the money movement. Such transformation rules can allow the movement of money from net credited balances of a merchant to another balance (e.g., a reserve balance to deal with risk reserve on pay-ins).

After applying the policies to the money movements of the transactions via any necessary modifications, policy engine 201 performs writes to send the transactions (e.g., mutated transactions) to book keeping system 202 with instructions that specify to book keeping system 202 as to the manner in which each transaction is to be fulfilled. In some embodiments, these instructions include all the account balances (e.g., regular balance, risk reserve balance, etc.) that are to be used to fulfil each transaction and/or the order in which they are applied.

In some embodiments, policy engine 201 can also assign or add a tag to each transaction. In some embodiments, the tag comprises a qualitative representation of a balance. The tag applies a context to the money as it moves through the book keeping system. This is particularly useful where policy engine 201 applies fund flow transformation rules to modify a transaction to be fulfilled with segmented into different account balances with each segment being tagged with a certain amount of the money movement. In some embodiment, policy engine 201 propagates the tags across the money movement including the source and destination account balances. In some embodiments, policy engine 201 propagates the tag to book keeping system 202 where the tag is persisted. In some embodiments, each tag comprises a key:value pair that is stored in a database.

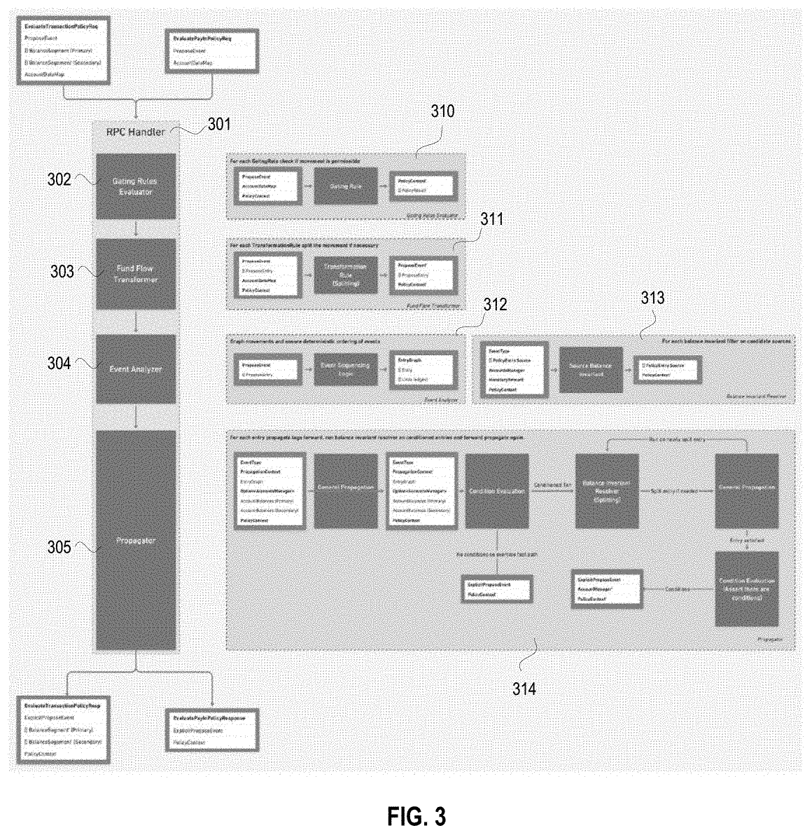

FIG. 3 illustrates some embodiments of a policy engine that performs a policy evaluation process on money movement transactions (e.g., money movement requests). In some embodiments, the policy engine is implemented, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 3, the policy engine includes an RPC handler 301 to handle the life cycle of a transaction. In some embodiments, each of these transactions comprises a request for money movement. RPC handler 301 takes validated requests in and drives the policy evaluation process performed by the policy engine. In some embodiments, RPC handler 301 includes a number of modules to process transactions including, but not limited to, a gating rule evaluator 302, a fund flow transformer 303, an event analyzer 304 and a propagator 305.

After RPC handler 301 receives each transaction, a gating rules evaluator 302 applies gating rules to each money movement request of the transaction. In some embodiments, the gating rules are hard pre-checks through which all fund flows go. Gating rules evaluator 302 can reject a transaction if the request of the money movement is not allowed by one or more gating rules. These determinations may be based on static data that can be found within the request. As an example, in some embodiments, gating rules evaluator 302 disallows transaction that involve a merchant in certain countries in which the payment processor doesn't operate. In some embodiment, when gating rules evaluator 302 rejects a transaction, gating rules evaluator 302 sends a failure indication or other message to the originator or predefined party indicating that the transaction has been rejected.

After the policy engine has performed the gating rules evaluation, a fund flow transformer 303 receives the transactions that passed the gating rules and determines whether one or more fund flow transformation rules apply to each transaction. The fund flow transformation rules impose constraints on the money movements that may be performed. In some embodiments, the policy engine supports the following classes of constraints: constraints that apply on merchants (customers) linked within a transaction, constraints that apply on how money should move for a GPTN fund flow and/or transaction, constraints that apply for the account balances that are linked within a transaction. Other constraints may be imposed by the policy engine.

If fund flow transformer 303 determines one or more fund flow transformation rules applies to a transaction, fund flow transformer 303 augments the transaction to dictate the way the fund flow for the request should occur. This augmentation process may include transforming, or mutating, a transaction based on predefined rules in order to adhere to system invariants that specify a policy to be applied to such a transaction. The resulting transformation still results in the same number of transactions; however, there may be more than one money movement associated with a transaction after transformation. For example, fund flow transformer 303 can transform a money movement by splitting the money movement into multiple transfers (e.g., serialized transfers, parallel transfers, etc.).

Note that if fund flow transformer 303 determines that no fund flow transformation rules apply to a transaction, fund flow transformer 303 leaves the transaction unchanged.

After fund flow transformer 303 has finished with each transaction, an event analyzer 304 computes a list of proposed entries to complete the money movements associated with the transaction (whether transformed or not). In some embodiments, the proposed entries includes an order list of money transfers that include correct source and destinations accounts (e.g., account balances, account numbers, etc.).

In some embodiments, event analyzer 304 transforms the money movement of a transaction into a graph representation of a proposed money movement that models ordered money movements in the transaction. In some embodiments, each graph includes a deterministic way to be traversed. In some embodiments, event analyzer 304 analyzes the graph and transforms it. As part of analysis, event analyzer 304 can sort the graph using a modified topological sort that based on flow order in which the money transfers are to be performed. For example, the graph may be sorted so that the money transfers occur serially from largest to smallest. In some embodiments, the graph may be sorted from net debited to net credited ordering of funds flow. However, other orders may be used.

After transforming the graph, event analyzer 304 materializes the planning entries into a plan containing final proposed entries, updated balances, and policy results. This may be performed in multiple stages: funding and balance selection. During the funding stage, event analyzer 304 creates funding entries to complete the money movement. After the funding stage, event analyzer 304 performs a balance selection stage where the account balances for the funds for the money movement are selected. In some embodiments, event analyzer 304 performs balance selection by running all of the planning entries though a DFS.

After event analyzer 304 is finished operating on a transaction, propagator 305 propagate tags across the transfers associated with each transaction. For example, as discussed herein, balances are used to fulfill money movements and those balances may have different tags. These tags can be added by the funds flow transformer as part of the use of the transformation rules. Such tags are propagated by propagator 305. In some embodiments, propagator 305 propagates account tags across the entire money movement chain, including where entries are linked together (e.g., a destination account of one is equivalent to the source of the other).

In one embodiment, propagator 305 also performs condition evaluation with respect to balances chosen to fulfill a fund flow of a transaction. This condition evaluation can involve adding conditions on certain balances when returning a response to the transaction.

In some embodiments, propagator 305 includes a balance invariant resolver that runs balance invariants as applied constraints on the list of source balances in the transaction while taking into account current balances and proposes a list of source balances and limits on amounts that can be drawn from each source balance.

As shown in FIG. 3, each of the components of RPC handler 301 includes one or more interfaces. In some embodiments, gating rule evaluator 302 includes a gating rule evaluation interface 310, fund flow transformer 303 includes a fund flow transformation interface 311, event analyzer 304 includes an event analysis interface 312, and propagator 305 includes propagation interfaces 314. These will be described in more detail below.

### Phase 1: Gating Rule Evaluation

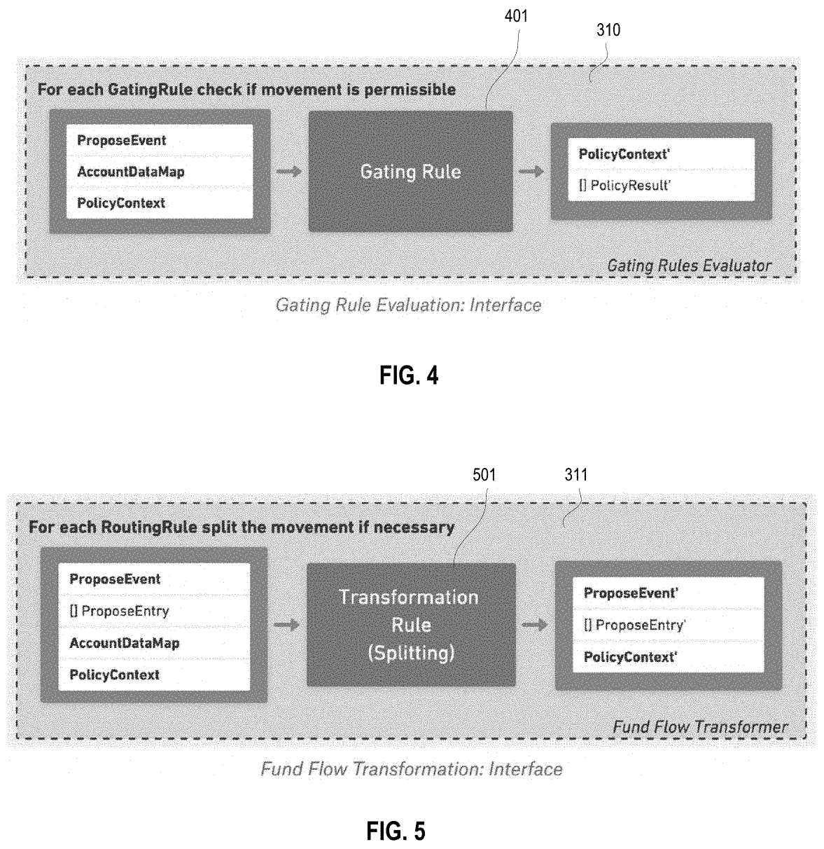

In some embodiments, gating rules are hard pre-checks that all fund flow should go through. In some embodiments, the gating rule evaluator 302 applies the gating rules to each transaction and the result of the application is an indication (e.g., a yes or no answer) as to whether or not a gating rule applies. If a gating rule does apply to the transaction, the policy engine is not going to augment the transaction and the transaction fails. In some embodiments, gating rules depend only on static data provided in the request. FIG. 4 illustrates one embodiment of a gating rule interface, such as, for example, gating rule interface 310 of FIG. 3.

Referring to FIG. 4, for each transaction (ProposeEvent), the gating rule evaluation applies a gating rule 401 that is checked. Examples of gating rule 401 include disallowing a transaction involving merchants (customers) in a country in which the payment processor using the policy engine doesn't operate (e.g., Iran) and only allowing a fund flow for certain transactions in a specific currency (e.g., manual payouts only work for US dollars). In some embodiments, if there is a failure at this step, the RPC handler returns a failure with the PolicyContext.

### Phase 2: Fund Flow Transformation

As mentioned above, the fund flow transformer augments a given transaction to abide by specific rules based on how a fund flow should operate. These rules may be specified by the payment processor or regulatory bodies. In some embodiments, the transformations are deterministic and don't depend on account balances but only on fund flow semantics.

FIG. 5 illustrates one embodiment of a fund flow transformation interface, such as, for example, fund flow transformation interface 311 of FIG. 3. Referring to FIG. 5, the fund flow transformation interface includes transformation rules, such as, for example, transformation rule 501. In some embodiments, the transformations rules describe how a money movement should happen at the payment processor and usually contain system invariants that apply to all customer services provided by a payment processor.

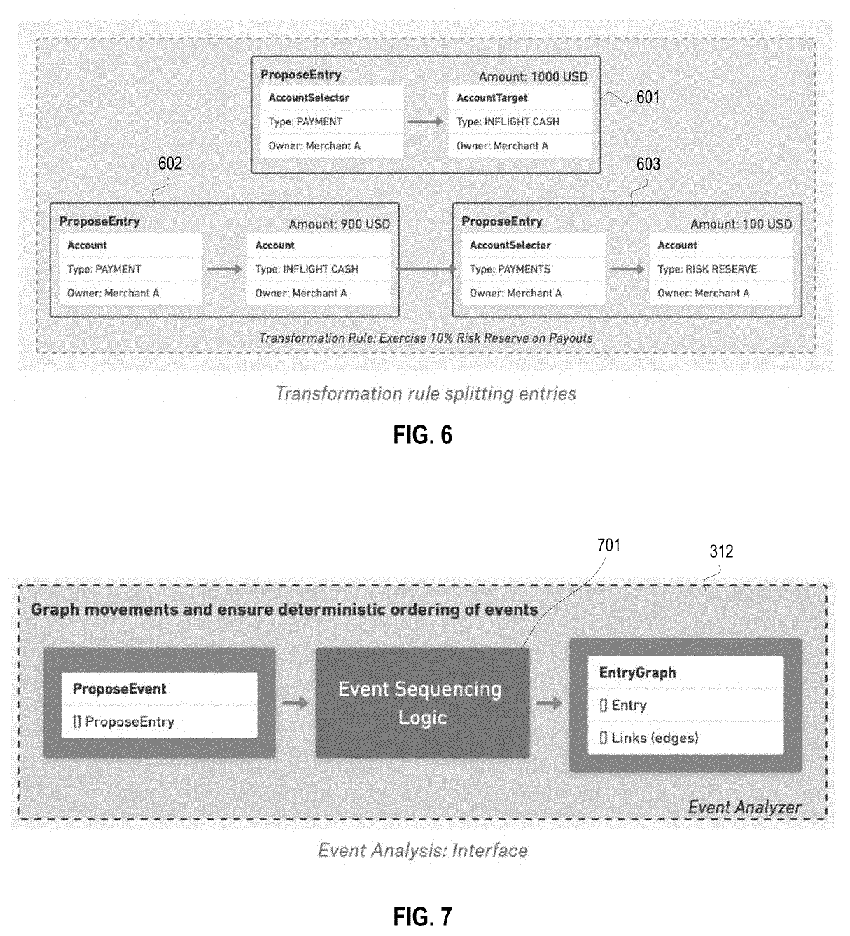

An example of a fund flow transformation rule is splitting a money movement into multiple transfers for completion by the book keeping system such as in the case of handling risk reserves by splitting the transaction into two parts, one of which goes to the risk reserve account of the merchant and the remainder to the payments balance (account). FIG. 6 illustrates an example of a transformation rule splitting entries. Referring to FIG. 6, transaction 601 includes a proposed money movement (ProposeEntry) that is a payout in the amount of $1000 USD to a merchant as a payment. The transformation rule is applicable to the transaction and calls for a 10% risk reverse on payout. In such a case, the transformation rule modifies the money movement of transaction 601 into two money movements (ProposeEntry) 602 and 603, in which the first money movement for $900 USD goes from one account (Payment) of the merchant (Merchant A) to another account (Inflight Cash) of the merchant (Merchant A) and the second money movement for $100 USD, equal to the 10% specified in the rule, goes from one account (Payment) of the merchant (Merchant A) to another account (Risk Reserve) of the merchant.

Another example of a fund flow transformation rule is that a regulated top-up value should be tagged as stored value.

### Phase 3: Event Analysis

As discussed above, the event analyzer pre-processes the transformed event and computes an ordered list of proposed entries to be written to the book keeping system where the money movement transaction is completed. In some embodiments, the event analyzer examines a transaction to ensure that there is only one net-debited source within a transaction and entry sequencing is deterministic.

FIG. 7 illustrates one embodiment of an event analysis interface, such as, for example, event analysis interface 312 of FIG. 3. Referring to FIG. 7, the event analysis interface includes event sequencing logic 701 that receives a proposed money movement (ProposeEvent) and returns a graph (EntryGraph) that models ordered money movements in the transaction. In some embodiments, the graph has references to the entries, the links within those entries, and a deterministic way in which the graph is to be traversed.

### Phase 4: Propagation

The propagator performs the propagation phase of the transaction processing. The propagation phase involves finding conditions on the policy-transformed movement, propagating tags, and optionally running balance invariants.

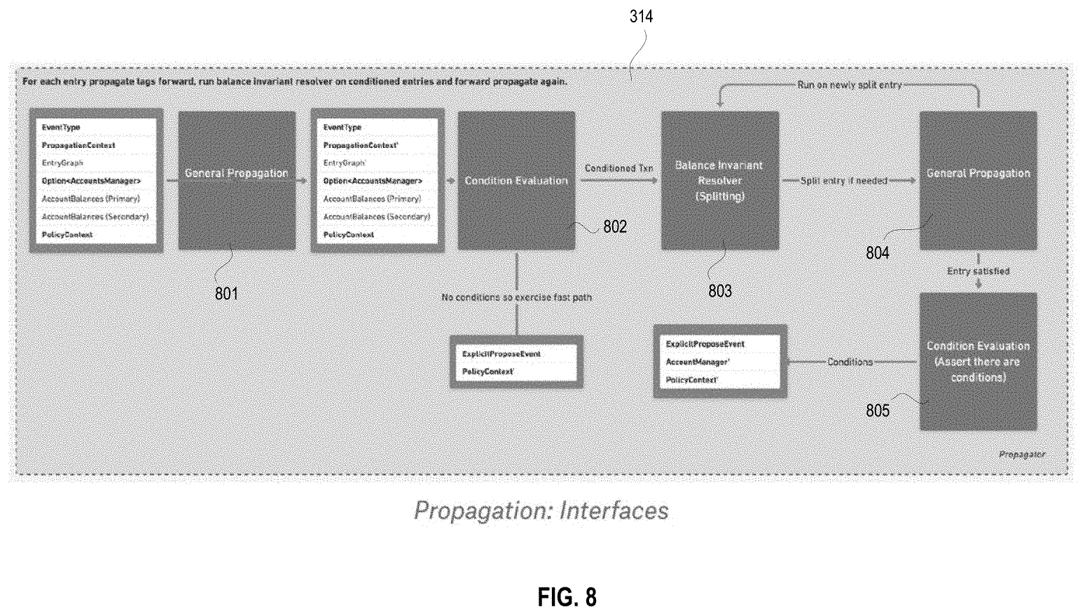

FIG. 8 illustrates one embodiment of propagation interfaces, such as, for example, propagation interface 314 of FIG. 3. Referring to FIG. 8, propagation interfaces includes a number of modules including general propagation module 801, condition evaluation module 802, balance invariant resolver module 803, general propagation module 804 and condition evaluation module 805. These modules are explained in more detail below. The references to PropagationContext in FIG. 8 refer to an entry to the propagation interfaces and is a wrapper around the entry graph from the event analyzer that helps with splitting the entries while maintaining order and propagating tags across the entry graph.

In some embodiments, modules of the propagation interfaces ensure that a number of system invariants are met for each money movement transaction. In some embodiments, these invariant include one or more of the following:
1) unconditioned accounts don't require account balances;
2) accounts with negative balances shouldn't be used as a net-debit source unless we are processing refunds;
3) tags are always propagated forward unless the entries explicitly specify otherwise;
4) entry splitting is performed on zero crossings when drawing from account balances to satisfy the movement amount; and
5) tag propagation is deterministic.

### Propagation Phase 1: General Propagation

General propagation within the policy engine refers to propagating the account tags across the entire money movement chain of a transaction. Given a money movement event may consists of multiple entries with source account balances and destination account balances, it is not uncommon for these entries to be linked together (e.g., destination of one entry is equivalent to the source of the other). In such scenarios, the propagator preserves the tags across the chain for the same type of accounts. This ensures that funds are not intermingled between different logical accounts.

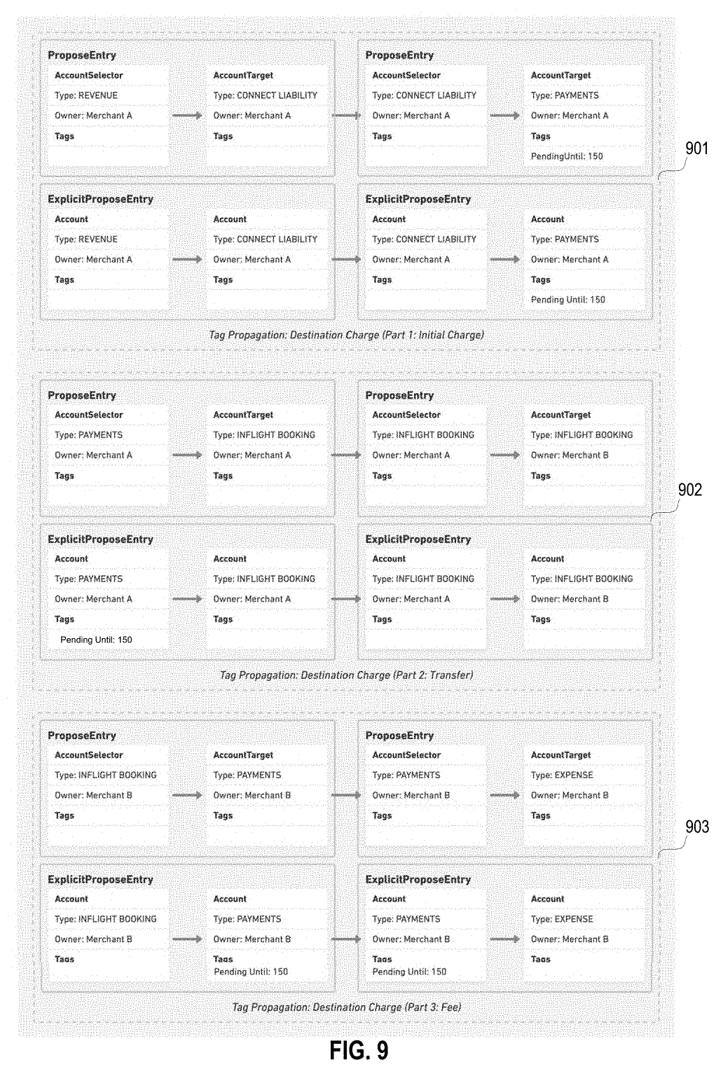

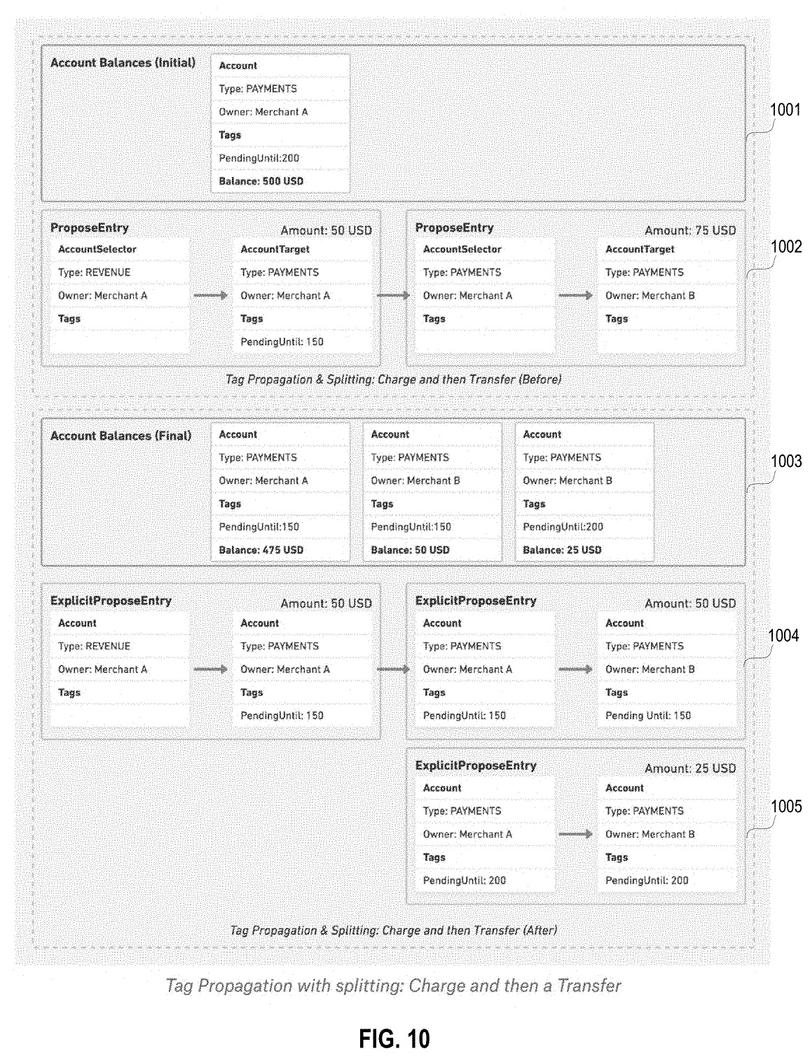

FIGS. 9 and 10 illustrate examples of tag propagation. FIG. 9 illustrates a case of tag propagation in the destination charge case. In this case, there is one event split across three parts 901-903, namely the initial charge, the transfer, and the fee. In part 901, the request specifies that the first part of the transaction, the initial charge, will come into the Payments account of A on a later time pending_until: 150. Assuming that Account A doesn't have any other available sub balances, this constraint has implications over the rest of the entries in the transaction as money movement at each step will be delayed. The policy engine handles such cases by propagating the tags to the relevant accounts. Notice that there is a tag propagated at every relevant Payments account in the chain: pending_until: 150

FIG. 10 illustrates that case of Tag Propagation with splitting in which there is a charge and then a transfer. Referring to FIG. 10, assume that Merchant A starts with an initial balance of $500 USD that is pending until a time 200 ms (1001). The money movement request specifies first doing a charge for $50 USD by Merchant A (1002), which is pending until a time 150 ms in future, and then doing a transfer of $75 USD from Merchant A to Merchant B (1002).

Subsequently, the final balances (1003) of the Payments account of Merchant A is $425 USD that is pending until a time 150 ms, Payments account of Merchant B is $50 USD that is pending until a time 150 ms, and Payments account of Merchant B is $25 USD that is pending until a time 200 ms. The

As shown above, in some embodiments, the policy engine splits transfer into two parallel transfers (1104 and 1005) where the first one will come from the funds created by the initial charge (as it has an earlier pending until expiry—this is a system invariant) and the second transfer will be funded by the other account balance for Merchant A (with a pending until of 200). The policy engine will take care of propagating the correct tags in both of the transactions.

### Propagation Phase 2: Condition Evaluation

In some embodiments, because the money movement transactions are operating on account balances and consistency must be maintained from the customer's point of view, the policy engine can optionally add conditions on certain balances when returning the response to the book keeping system to ensure consistency. These conditions are evaluated prior to resolving balance invariants.

Note that if there are no conditions on a money movement, there is a fast path in which such a transaction is completed more quickly than if conditions existed on the money movement. For example, in some embodiments, for transactions having money movements involving money being transferred into the payment processor, these money movements are not conditioned and therefore may be completed in a faster manner.

### Propagation Phase 3: Balance Invariant Resolver

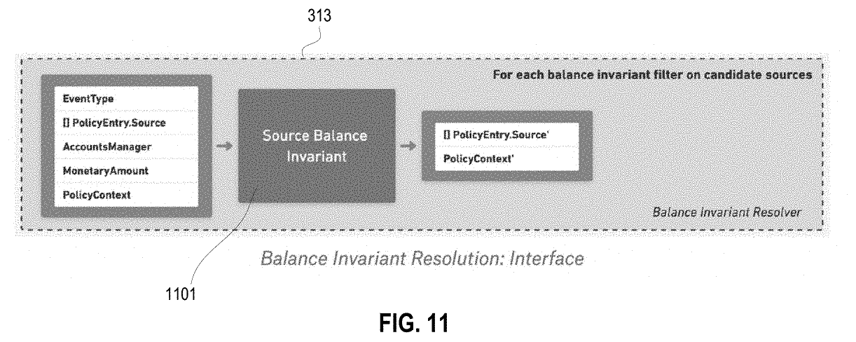

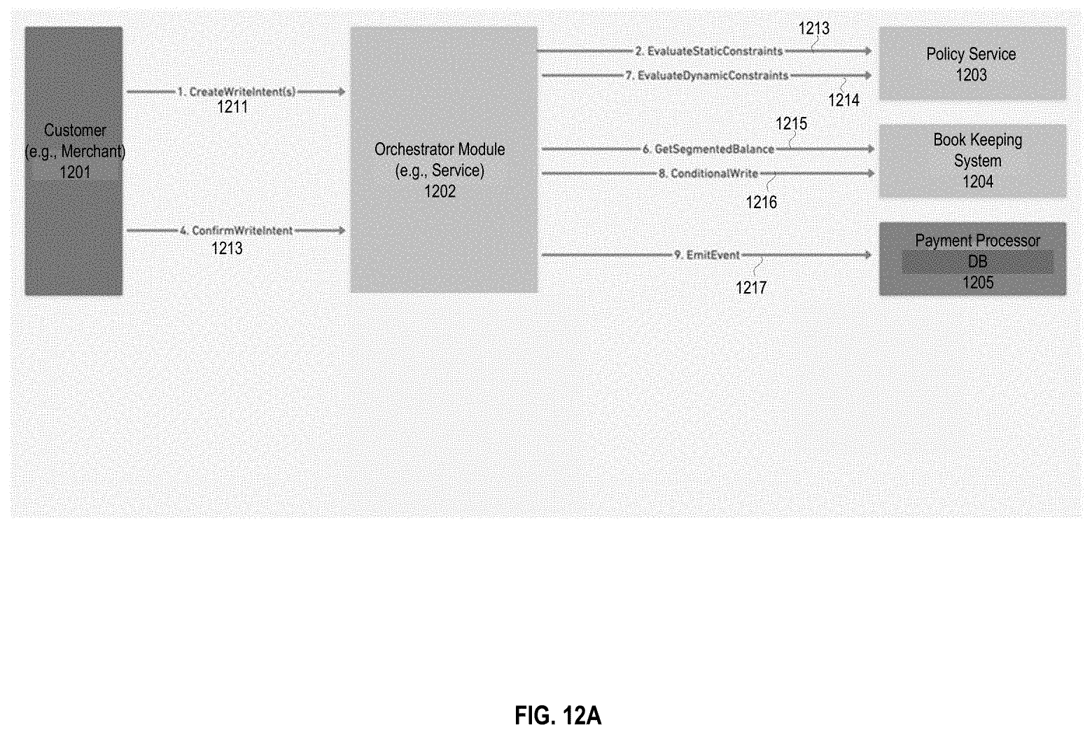

In propagation phase 3, a balance invariant resolver with a resolution interface runs relevant balance invariants on the list of source account balances for the money movements in a transaction while taking into account the current account balances. FIG. 11 illustrates one embodiment of a balance invariant resolution interface. Referring to FIG. 11, the balance invariant resolution interface, such as, for example, balance invariant resolution interface 313 of FIG. 3, includes a source balance invariant module 1101 that runs relevant balance invariants on the list of sources as part of the balance invariant resolver. The balance invariant resolver then proposes a list of source account balances and a limit as to the amount that can be drawn from each source in order to complete a money movement. In some embodiments, every balance invariant is individually deterministic. In some embodiments, examples of balance invariants include sources having sufficient funds and sources are selected based on which balance is the earliest available to fulfill a money movement.

The proposed list of source account balances, each of which is tagged, is then subject to general propagation 804. In cases where there are split entries (e.g., a money movement is split into multiple money movements to complete a transaction), those entries are feedback and run through balance invariant resolver 803 again. Subsequently, the money movement entries with their balances tagged are propagated to condition evaluation 805, which evaluates any existing conditions to determine whether the transaction can be completed as set forth or is to be rejected.

### Orchestrating Money Movement Transactions

In some embodiments, the policy engine uses an orchestrator in order to provide a central point for processing money movement transactions. In some embodiments, the orchestrator uses one or more APIs to write money movement transactions to the bookkeeping system and orchestrates the money movement transactions through the system.

In some embodiments, the orchestrator uses a policy orchestration protocol to validate or authorize money movement transactions prior to the time that they are to be committed. If the orchestrator determines that the money movement is valid, then the money movement is allowed to proceed and ultimately be sent to bookkeeping system. In some embodiments, the determination of whether money movement is valid is based on determination of whether the money movement is legal or not. That is, in some embodiments, the orchestrator acts as a coordinator between the rest of the policy engine and the bookkeeping system to first deem the money movement legal and then perform the money movement. In some embodiments, the money movement transaction is received by the orchestration system in the form of a write operation. The orchestrator would then determine if the write is legal and then persist the write durably.

In some embodiments, the orchestrator has only one defined call flow that callers call when they know they intend to initiate a money movement transaction during the lifetime of the money movement request. This API returns whether the request is a legal money movement, and if not the customer (e.g. merchant, etc.) cannot proceed further with the money movement. In this way, the orchestration API licenses the money movements. After being deemed legal, the customer must confirm the money movement at some time later by calling another API.

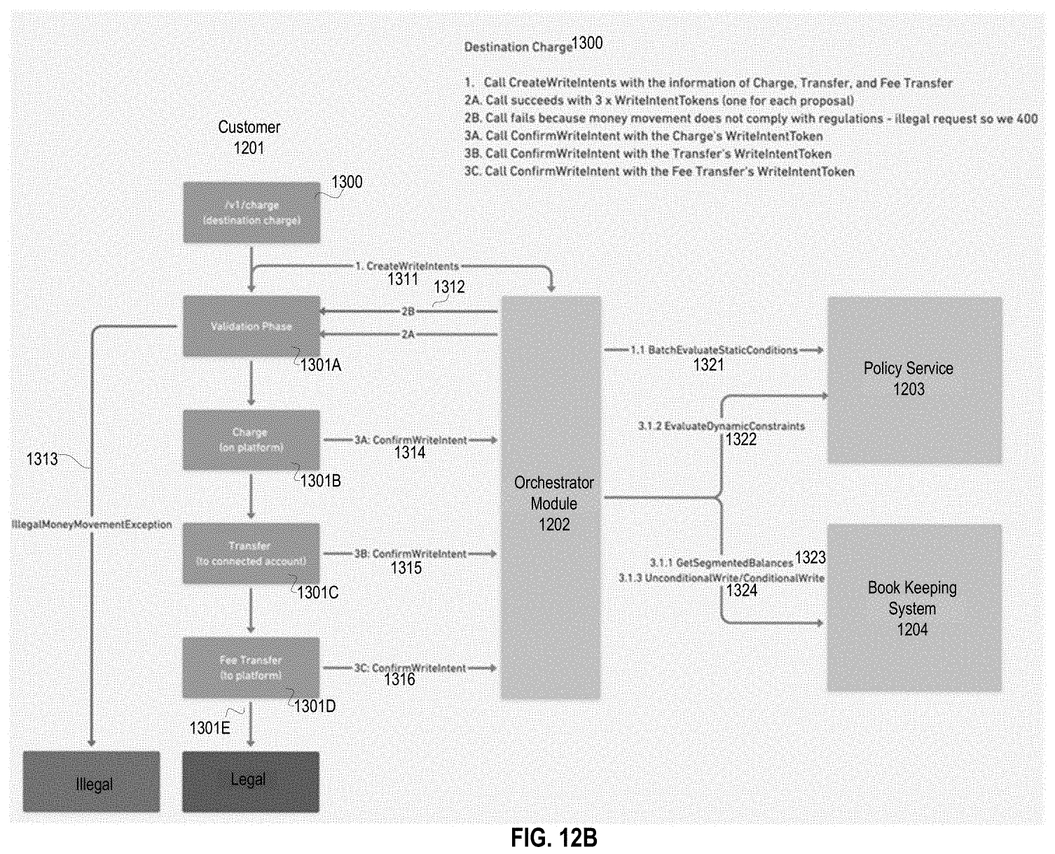

FIG. 12A illustrates a sequence diagram of a call flow between various parts of some embodiments of a payment processing system. In some embodiments, the sequence is performed based on the policy orchestration protocol using an orchestrator. In some embodiments, the policy orchestration protocol is based on two-phased intent model where a customer (e.g., a merchant, etc.) creates an intent to write a money movement, as a transaction, to the bookkeeping system and then at a later time when the customer is “ready”, the customer confirms that intent.

In some embodiments, using the two-phased intent model, before moving funds, a customer requests a license to make a proposed money movement. In some embodiments, the proposed money movement comprises proposed changes to account balances of one or more accounts handled or otherwise controlled by the payment processor. To that end, the customer calls an API when it knows all money movements associated with a transaction that it needs to propose. The customer is allowed to write these intents when it has enough information that the policy engine needs to determine whether the money movement is legal or not.

Referring to FIG. 12A, customer 1201 creates a write intent 1201 corresponding to a money movement transaction and sends it to the orchestrator module 1202. In some embodiments, orchestrator module 1202 comprises hardware (e.g., circuitry, dedicated logic, etc.), software (e.g., software running on a chip, software run on a general-purpose computer system or a dedicated machine, etc.), firmware, or a combination of the three. In one embodiment, orchestrator module 1202 is a service performed by a server.

In some embodiments, in response to receiving the intent 1211, orchestrator module 1202 translates the incoming money movement to a policy specific proposal for evaluation to check whether the money movement is legal. After performing the translation, orchestrator module 1202 sends the translated request to policy service 1203 to evaluate the money movement with respect to static constraint 1212. In some embodiments, the static constraints correspond to the gating rules described above. In response to the request 1212 to evaluate the money movement with respect static constraints, policy service 1203 performs the evaluation. In some embodiments, policy service 1203 also runs transformation rules and tagging modules described above.

After evaluating the money movement with respect to the static constraints, policy service 1203 indicates to orchestrator module 1202 whether the static constraints have been passed. In some embodiments, policy service 1203 applies the gating rules to determine whether any of the gating rules apply to the money movement to determine whether the transaction is allowed to proceed and then sends the results (e.g., a yes or no indication) to orchestrator module 1202.

In response to the indication of whether the transaction is allowed to proceed, orchestrator module 1202 determines whether to issue a license for the money movement transaction or not. If policy service 1203 indicates that the money movement transaction is legal, orchestrator service 1202 issues a license to customer 1201 indicating that it can proceed. If policy service 1203 indicates that the money movement transaction is not legal, orchestrator module 1202 sends an indication to customer 1201 that the money movement transaction failed. At that point, customer 1201 handles the failed transaction in a manner well known in the art, such as rejecting the transaction that causes the money movement transaction to be created in the first place. In one embodiment, the license is in the form of a token that is used by the customer 1201 in the future with the customer's final going to confirm the money movement transaction.

Subsequently, when customer 1201 is ready to confirm the money movement transaction, customer 1201 sends a request 1213 to confirm write intent with the write token (license) to orchestrator module 1202. In response, orchestrator module 1202 checks whether the token exists (e.g., has been previously been provided by orchestrator module 1202). If orchestrator module 1202 determines that the token does not exist, orchestrator module 1202 will fail the request of the money movement transaction and send that indication back to customer 1201. If the token does exist, orchestrator module 1202 processes the money movement transaction further to commit the money movement transaction.

When processing the money movement transaction further, orchestrator module 1202 determines whether the transaction is conditioned on another event and if so, has the event been committed. In some embodiments, if that other event has not been committed, orchestrator module 1202 will fail the request. For example, if a money movement transfer involves receiving a payment into the payment processor account and transferring at least part of that payment to an account of another party, which is conditioned on the occurrence of the first payment being received into the payment processor account, then orchestrator module 1202 will fail the request transfer unless the first payment into the payment processor account succeeded.

If orchestrator module 1202 determines that the token does exist, orchestrator module will commit the intent immediately by calling bookkeeping system 1204 if there are no conditions are on the request money movement transaction. If the transaction is conditioned, the orchestrator module 1202 sends a request to the bookkeeping system 1204 to obtain balances (get segmented balances 1215) and calls policy service 1203 with a request to evaluate dynamic constraints (e.g., evaluate that dynamic constraints request 1214). In response to the request to evaluate dynamic constraints 1214, policy service 1203 indicates whether the dynamic constraints have been met. For example, using the balances obtained from the bookkeeping system 1204, orchestrator module 1202 determines whether the money movement transaction as proposed is possible in view of current account balances associated with the money movement request as part of performing the dynamic constraints evaluation. Policy service 1203 may determine that the proposed money movement in the money movement transaction is not possible based on the account balances that currently exist in the bookkeeping system 1204. If after fetching account balances and evaluating dynamic constraints, orchestrator module 1202 determines that the money movement transaction may be committed, then orchestrator module 1202 performs a write 1216 to write the money movement transaction to bookkeeping system 1204 to complete the transaction.

In some embodiments, orchestrator module 1202 may also emit an event indication 1217 for storage in the payment processing database 1205 to record the transaction and its associated data.

Thus, as shown above, the orchestration policy protocol sets up an initial authorization/authentication call sequence implemented by orchestrator module 1202 to determine whether a money movement transaction is legal and then subsequently sets out to complete the money movement transaction when the customer is ready to commit the money movement. This is very helpful in preventing customer situations in that a customer is notified earlier in the overall transaction processing that a transaction is not legal and not going to proceed prior to such information showing up on a customer dashboard giving the customer a false impression that the transaction has gone through and the account balances being shown on their dashboard are accurate.

FIG. 12B illustrates an example of a destination charge being handled by some embodiments of an orchestrator module. This destination charge is a chained flow movement that has many separate transfers involved.

Referring to FIG. 12B, customer 1201 issues a destination charge request 1300. When this occurs, customer 1201 sends the writing intent call 1311 to orchestrator module 1202 with information that specifies the charge, a transfer between two users of the payment processor, and a fee transfer for the fee to be paid to the payment processor, all of which are associated with the money movement.

In response to write intent call 1311, orchestrator module 1202 determines as described above whether the money movement transaction is legal. Because the destination charge includes three proposed transfers, orchestrator module 1202 determines whether each proposed transfer in the money movement transfer is legal. For all the proposed transfers in the money movement request, orchestrator module 1202, working with policy engine 1202, translates all the entries into a single money movement graph as described, runs the static constraint checks and then runs of each of the individual proposed transfers to determine whether each proposed transfer is legal. To that end, orchestrator module 1202 will provide an indication to customer 1201 for each proposed money movement within the money movement transaction to indicate that proposed money movement transfer may proceed further. In some embodiments, orchestrator module 1202 issues a license (e.g., a token) for each of the transfers indicating that proposed money movement transfer may proceed further.

As part of the validation phase, if orchestrator module 1202 determines that any of the proposed transfers of the destination charge is not legal (e.g., the fails because the money movement does not comply with the regulations, etc.), orchestrator module 1202 provides a failure notice 1312 to the customer indicating that the money movement is illegal 1313.

Thereafter, when customer 1201 wishes to commit charge 1300, customer 1201 sends write intents to be confirmed for each of the proposed transfers to orchestrator module 1202 as confirmed write intent 1314, 1315, and 1316. In response thereto, if the write intents to be confirmed are conditioned, orchestrator module 1202 sends a request 1323 to the bookkeeping system 1204 to obtain the account balances associated with each of the transfers and sends a request 1322 to policy service 1203 to evaluate dynamic constraints. Assuming the dynamic constraints are met, orchestrator module 1202 sends a conditional write to the bookkeeping system 1204 to commit the write operation. Note that in some embodiments, in a case where there are multiple proposed money movements as part of one transaction, such as destination charge 1300, all of the transfers must commit or none of them are allowed to commit. In the write intents to be confirmed are not conditioned, orchestrator module 1202 sends a conditional write to the bookkeeping system 1204 to commit the write operation.

Handling Risk Reserves with a Policy Engine

In some embodiments, the policy engine processes transactions based on policies that cause funds to be reserved on a per transaction basis. The policy engine applies transformation rules to create money movements for each transaction where one of the money movements is for creating a risk reserve for the transaction. The policy engine determines if holding funds of a merchant as a risk reserve is necessary for transactions of a merchant and then causes the reserve amount of funds to be taken from and held for each transaction. In some embodiments, the reserved funds are held for a particular transaction until a fulfillment date, which corresponds to the date that an event happens that causes the reserved funds to no longer be necessary to compensate for the risk associated with that transaction. In some embodiments, reserve balances are modeled as payments balances with a time expiry that indicates the time when reserved funds are to be released.

In some embodiments, the transaction-based risk reserves are forward-looking and reserve a percentage of each transaction. Note this is different than the existing reserves handling described in the Background section, which “fills-up” reserves based on an ideal amount calculated using on processing volume in the looking-back window. Embodiments of the transaction-based risk reserves processing system herein have one or more of the following goals. First, the system is robust against risk exposure. By taking reserves synchronously at the time money enters a merchant's balance as opposed to later at payout time, this system provides a more robust defense against risk exposure. Second, the transaction-based risk reserves enables the handling of risk reserves in a manner that is explainable to the merchant. In other words, the payment processor is able to explain to a merchant what they should expect to see when a risk reserve is placed on them. While a risk reserve is placed, the payment processor is able to explain what is and what will be happening with the merchant's account, including providing information about when reserves will become available to the merchant. Additionally, the system enables an explanation to be provided to merchants about which reserves are tied to specific transactions that “contributed” to the reserve for their bookkeeping. Thus, the system is auditable by the merchant. Given the information provided to them by the payment processor, a merchant should be able to validate their fund flows and be convinced that the numbers match their expectations.

On a high level, in handling risk reserves on a per transaction basis, there are entry points (pay-ins) and exit points (pay-outs) out of a reserve balance of a merchant. In some embodiments, the policy engine is that entry point and the booking system is handles the payouts. In some embodiments, the system handles risk reserves on transactions involving charges and payments.

In some embodiments, the policy engine (e.g., policy engine 201) performs at least part of the transaction-based risk reserves processing, and the processing starts during the charge path as money is coming in for a transaction and a portion of the transaction amount needs to be reserved. In some embodiments, the portion of the transaction amount is a percentage of the charge for the merchant and this amount is to be moved to their reserve balance.

In some embodiments, the policy engine intercepts all book keeping rights transactions and determines which policy rules, including risk rules, to apply to each transaction, if any. In some embodiments, this determination is made by inspecting a set of attributes of each transaction to determine if a policy rule applies. These attributes can relate risk rules that apply to a merchant (or other customer) associated with the transaction, along with other transaction related information such as, for example, but not limited to, a purpose of money movement (e.g., top off an account, top off for future refund or dispute, transfer between two accounts of payment processor, etc.), an amount of the transaction, etc.).

In some embodiments, the policy engine uses one or more transformation rules to mutate a transaction by splitting a single money movement of the transaction into multiple segmented money movements. These transformation rules enable another, different account (balance) to be added to the fund flow to implement the money movement, including allowing the movement of money from net credited balances of a merchant to a reserve balance to deal with risk reserve on pay-ins.

An example of a fund flow transformation rule is splitting a money movement into multiple transfers for completion by the book keeping system when handling risk reserves. In this case, the transformation rule splits the transaction amount into two parts, one of which goes to the risk reserve balance (account) of the merchant and the remainder to the payments balance (main or regular account). In this example, a transformation rule splits a proposed money movement that is designated as a payout to a merchant into two money movement transactions. The transformation rule is applicable to the transaction and calls for a predetermined percentage as a risk reverse on payout. In such a case, the transformation rule modifies the money movement of the transaction into two money movements, in which one money movement for a percentage (e.g., 90%) of the overall transaction amount goes from one account (e.g., a payments or main account) of the merchant to another account of the merchant and the second money movement for the remaining percentage (e.g., 10%) as specified in the rule, going from one account (a payments or main account) to a risk reserve account of the merchant.

In some embodiments, the reserve amount is a predetermined amount (e.g., percentage, set amount for each, etc.) and is held in reserve until a fulfilment date. In some embodiments, the fulfillment dates is event occurs in the future. The event can be the expiration of a time period (e.g., number of months, number of days, etc.) or the occurrence of an event. For example, a ticket broker may sell tickets to a concert, sporting event, or other type of event that is set to occur in the future. In some cases, a risk reserve may be required to be held until that event has taken place. After the event has occurred, the reserve is released.

In some embodiments, the reserve amount to be taken from the transaction amount is specified in the transformation rule applied by the policy engine and is set based on an individual reserve plan associated with the merchant. In other words, the reserve plan of the merchant indicates when risk reserves are to be taken. In some embodiments, every merchant has a reserve plan that applies to all transactions for the merchant. In some embodiments, the reserve plan is set when a merchant is onboarded into the payment processor to have these payments handled. When processing a transaction, the policy engine evaluates attributes that are coded and sent with the transaction that indicate the transaction is for a particular merchant. In some embodiments, the policy engine identifies the particular merchant associated with a transaction by evaluating its attributes and then applies the reserve plan, if any, on the transaction if there is no other fulfillment event associated with the transaction. In some embodiments, such a fulfillment event, if any, is coded in the attributes.

After transforming a transaction into two (or more) money movements, which include one money movement designed to be a risk reserve, the policy engine sends the transaction to the book keeping system. In some embodiments, the policy engine sends the transaction using one or more write operations. Thereafter, the book keeping system maintains the risk reserves through to their fulfillment date.

In some embodiments, the book keeping system maintains the risk reserve balance for each transaction separately from the other risk reserve balances. That is, the book keeping system maintains a risk reserve balance for each transaction that has a risk reserve held. While there may be a reserve balance for every transaction, in some embodiments if there are only a limited number of balances that can be created and used for risk reserves, then the book keeping system creates individual balances for many or most transactions and includes one reserve balance that includes the reserves of a number of transactions. These transactions could be transactions that have fulfillment dates much later in time (e.g., over a year from the transaction time). As time passes, each transaction can leave this combined reserve balance to become a separate reserve balance for that transaction. For example, if a reserved balance of one transaction has an expiry date at a year and five days, the reserve balance may be put in the reserve balance shared by many transactions. However, after 6 days have passed, the reserved balance of the one transaction is moved out of the shared reserve balance and into its own (unshared) reserve balance.

In some embodiments, the book keeping system allows the expired reserve balances of money to be paid out to the merchant, thereby fulfilling the payout of the remainder of the transaction amount to the merchant. In some embodiments, once a reserve balance has been created, the book keeping system uses a payout path to release the funds. In some embodiments, this release can occur after the risk window has passed or if there is a refund and/or dispute associated with the transaction.

In some embodiments, the release of funds occurs according to an order. For example, in some embodiments, the fulfillment event for multiple transactions with held reserves may be same (e.g., the fulfilled reserve balances are fulfilled by the same event). Examples of such situation includes risk reserve balances having the same expiration time period or occurrence of some commercial event (e.g., concert, sporting event, etc.). If this occurs, the book keeping system orders the release of the reserve balances based on an order. The order can be risk reserve balances of the oldest transaction to newest transaction. The order can be risk reserve balances of the oldest balance to newest balance. Other orders may be used.

Once the reserve balance is to be released, and any release order determined, the book keeping system issues instructions to transfer the funds from the reserve balances for each transaction to payout logic. In response to the instructions, the payment is made to a destination. In some embodiments, the destination is the original destination specified or planned for the transaction for which the funds were reserved.

When handling a disputed transaction or refund in which the merchant is trying to issue a refund on a transaction, the booking system can release the reserve balance for a transaction. In some embodiments, the refunds and disputes are symmetrical to the initial charge (wherever possible) so that the book keeping system is able to attribute the reserve balance to the previous transaction charge, so that the charge can be reversed. In some embodiments, for refunds, the reserve balance is transferred to a payments account balance and the entire amount of the refund is made from the payments account balance.

Note that when reserve funds are paid out, the tags associated with the transaction and the reserve balance are discarded.

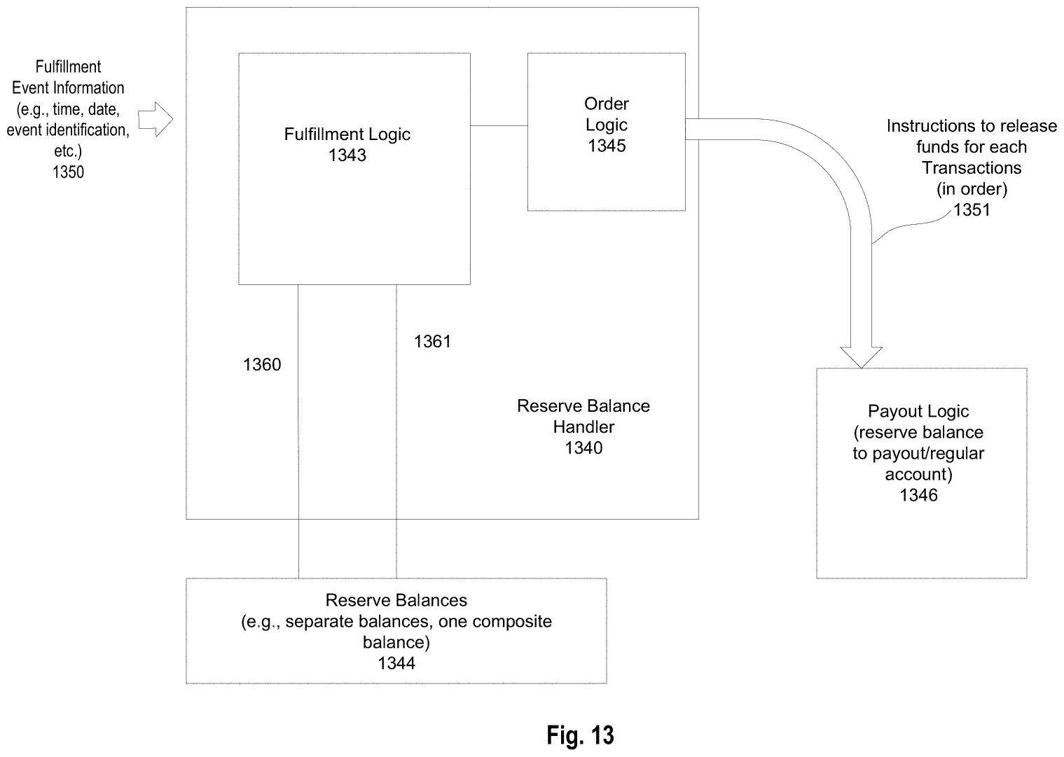

FIG. 13 is a data flow diagram of some embodiments of processing logic for handling reserve balances. In some embodiments, the processing logic comprises hardware (e.g., circuitry, dedicated logic, etc.), software (e.g., software running on a chip, software run on a general-purpose computer system or a dedicated machine, etc.), firmware, or a combination of the three. In some embodiments, the processing logic of FIG. 13 is part of a book keeping system.

Referring to FIG. 13, reserve balance handler 1342 receives fulfillment event information 1351. In some embodiments, fulfillment event information 1351 includes an indication of time for determining expiration of reserve balance time periods and information that indicates one or more events has occurred. For example, the time indication information can include information indicating a time of day and information indicating a date. Event occurrence information can indicate that certain events (e.g., sporting events, concerts, etc.) for which a reserve balance was held pending occurrence of the event have actually occurred.

In some embodiments, reserve balance handler 1342 also receives refund/dispute requests 1352 for transactions. Requests 1352 include information identifying transactions with reserve balances that are being returned due to the transactions being subject to a refund and/or dispute.

Fulfillment logic 1343 of reserve balance handler 1342 receives fulfillment event information 1351 and refund/dispute requests 1352 and uses the information to send queries 1360 to reserve balance storage 1344 to identify any reserve balances stored therein that have conditions fulfilled by the information in fulfillment event information 1351 or are subject to refund/dispute requests 1352. In some embodiments, reserve balances are stored separately from each other for each transaction in reserve balance storage 1344. Alternatively, some reserve balances are stored separately from each other for each transaction in reserve balance storage 1344, while a portion (or all) are stored in a common area. In some embodiments, reserve balance storage 1344 includes a tag balance database that stores tags associated with transactions and the reserve balances that have been persisted to the book keeping system.

In response to queries 1360, fulfillment logic 1343 receives responses 1361 identifying reserve balances with events that have been fulfilled or are part of refunds/disputes. In some embodiments, responses 1361 includes information identifying the transaction associated with each reserve balance and well as any corresponding tag. In response to the information, fulfillment logic 1343 provides an indication of the reserve balances and transaction information to order logic 1345.

In response to the reserve balance information, order logic determines if one or more of the fulfilled reserve balances are fulfilled by the same event (e.g., the same expiration time period or occurrence of some commercial event (e.g., concert, sporting event, etc.) and, if, orders the release of the reserve balances based on an order (e.g., oldest transaction to newest transaction; oldest balance to newest balance, etc.).

Order logic 1345 the issues instructions 1352 to transfer the funds from the reserve balances for each transaction identified as part of responses 1361 to payout logic 1346 in any determined order. These instructions include instructions for fulfilled transactions as well as transactions being refunded or disputed. In response to the instructions, payout logic 1346 transfers the funds according to the transaction information.

### Example Data Flow Diagrams for Money Movement Transaction Processing and Orchestration

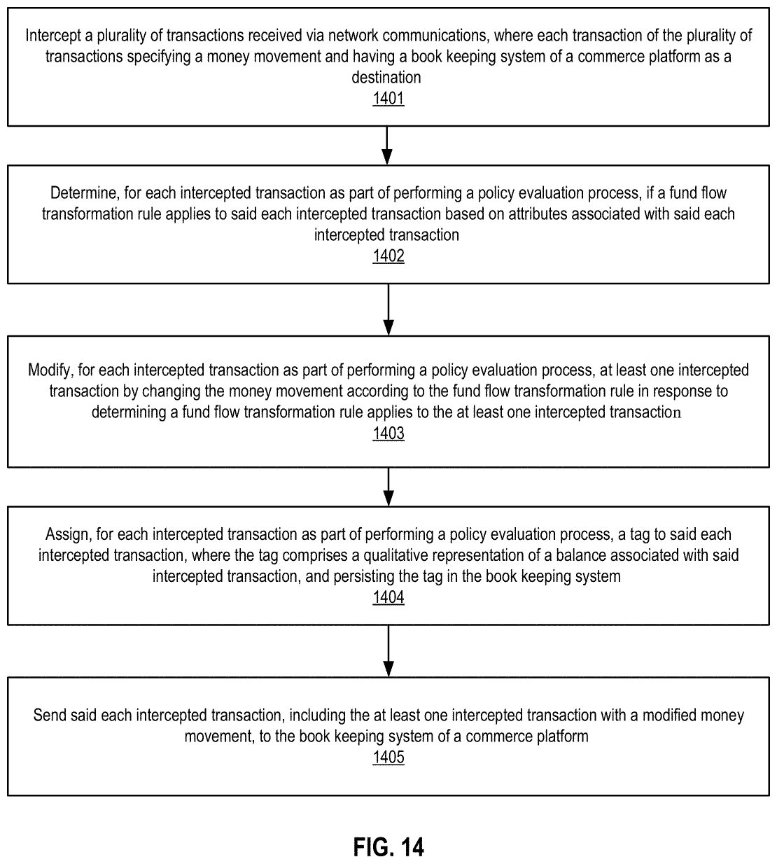

FIG. 14 is a data flow diagram of one embodiment of a process for processing money movement transactions. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 14, the process starts by processing logic intercepting a plurality of transactions received via network communications, where each transaction of the plurality of transactions specifying a money movement and having a book keeping system of a commerce platform as a destination (processing block 1401).

After intercepting transactions, processing logic determines, for each intercepted transaction as part of performing a policy evaluation process, if one or more fund flow transformation rules applies to each intercepted transaction based on attributes associated with each intercepted transaction (processing block 1402). In some embodiments, the attributes include one or more of an amount associated with the money movement of a transaction, a purpose of the money movement, a party associated with a transaction.

After determining whether a fund flow transformation rules to each intercepted transaction, processing logic modifies at least one intercepted transaction by changing the money movement according to the fund flow transformation rule (processing block 1403). In some embodiments, modifying the at least one intercepted transaction is based on an invariant. In some embodiments, modifying an intercepted transaction comprises splitting the money movement into segmented money movements, including specifying balances to be used to complete each money movement of the plurality of money movements.

In some embodiments, the policy evaluation process comprises analyzing a graph representing the money movement, and further wherein changing the money movement according to the fund flow transformation rule comprises mutating the graph based on the fund flow transformation rule. In some embodiments, after mutating the graph, processing logic determines which balances to use to complete the money movement of the at least one intercepted transaction according to the mutated graph and an ordering in which the balances are applied.

Processing logic can also assign, for each intercepted transaction as part of performing a policy evaluation process, a tag to each intercepted transaction, where the tag comprises a qualitative representation of a balance associated with said intercepted transaction, and persisting the tag in the book keeping system (processing block 1404).

Processing logic sends each intercepted transaction, including any intercepted transaction with a modified money movement, to the book keeping system of a commerce platform for completion (processing block 1405). In some embodiments, this may entail performing writes to the book keeping system.

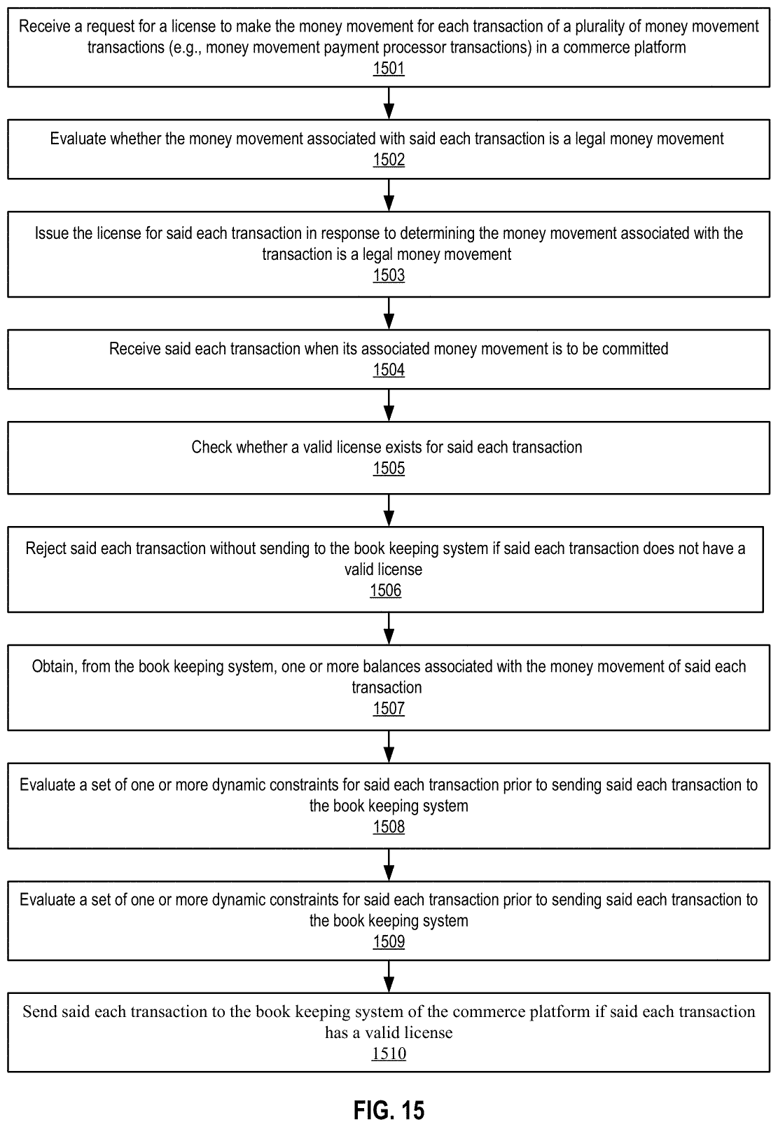

FIG. 15 is a data flow diagram of one embodiment of a process for orchestrating money movement transactions. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process can be performed by an orchestrator, such as, for example, described above (e.g., FIGS. 12 and 13 and accompanying text).

Referring to FIG. 15, the process starts by processing logic receiving a request for a license to make the money movement for each transaction of a plurality of money movement transactions (processing block 1501). In some embodiments, the money movement transactions are processed by a payment processor in a commerce platform.

After receiving a request, processing logic evaluates whether the money movement associated with each transaction is a legal money movement (processing block 1502). In some embodiments, evaluating whether the money movement of each transaction is a legal money movement comprises checking static restraints based on attributes associated with that transaction. In some embodiments, the attribute scan include an amount associated with the money movement of a transaction, a purpose of the money movement, and/or a party associated with a transaction.

Processing logic issues issuing the license for each transaction in response to determining the money movement associated with the transaction is a legal money movement (processing block 1503). Processing logic issues the license back to the requester (e.g., a customer through a payment processor API). In some embodiments, issuing the license and checking whether a valid license exist are performed by a single entity (e.g., an orchestrator, a service, etc.). In some embodiments, the license comprises a token.

Subsequently, processing logic receives each transaction when its associated money movement is to be committed (processing block 1504). In some embodiments, the transaction is sent from the customer (e.g., merchant) that issued the original request for the license for the transaction.

In response to receiving the transaction, processing logic checks whether a valid license exists for the transaction (processing block 1505). Processing logic rejects a transaction without sending to the book keeping system if the transaction does not have a valid license (processing block 1506). If the transaction has a valid license, processing logic obtains, from the book keeping system, one or more balances associated with the money movement of the transaction (processing block 1507) and evaluates a set of one or more dynamic constraints for said each transaction prior to sending said each transaction to the book keeping system (processing block 1508). In some embodiments, at least one dynamic constraint that is checked is a check regarding a balance of the one or more balances.

Assuming the transaction has a valid license and any dynamic constraints associated with the transaction are met or otherwise passed, processing logic sends the transaction to the book keeping system for completion therein (processing block 1509).

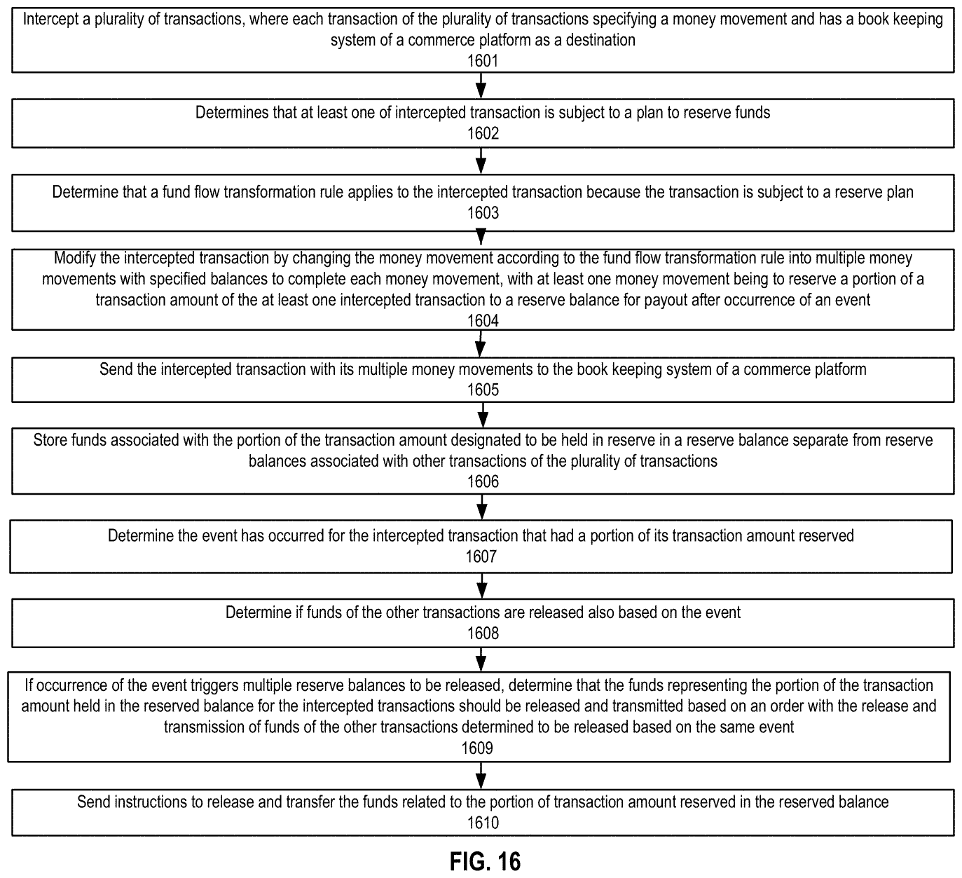

FIG. 16 is a data flow diagram of one embodiment of a process for processing money movement transactions that involve risk reserves. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 16, the process starts by processing logic intercepting a plurality of transactions, where each transaction of the plurality of transactions specifying a money movement and has a book keeping system of a commerce platform as a destination (processing block 1601). In some embodiments, these transactions are received via network communications (e.g., HTTP requests) that are directed to a computer system or server of the book keeping system.

In response to the transactions, processing logic determines that at least one of intercepted transaction is subject to a plan to reserve funds (processing block 1602). In some embodiments, processing logic makes this determination based on one or more of the attributes of the transaction. In some embodiments, these attributes accompany the transaction when its intercepted and include one or more of an amount associated with the money movement of a transaction, a purpose of the money movement, a party (e.g., newly onboarded merchant, occurrence an event (e.g., concert, sporting event, etc.) associated with a transaction.

If an intercepted transaction is determined to be part of a plan to reserve funds, processing logic determines that a fund flow transformation rule applies to the intercepted transaction (processing block 1603). In some embodiments, determining that the fund flow transformation rule applies to the intercepted transaction is part of a policy evaluation process.

In response to determining a fund flow transformation rule applies, processing logic modifies the intercepted transaction by changing the money movement according to the fund flow transformation rule into multiple money movements with specified balances to complete each money movement, with at least one money movement being to reserve a portion of a transaction amount of the at least one intercepted transaction to a reserve balance for payout after occurrence of an event (processing block 1604). In some embodiments, processing logic performs the modification of the intercepted transaction as part of a policy evaluation process.

In some embodiments, the portion of the transaction amount is reserved to account for risk associated with this one intercepted transaction being completed. In some embodiments, the portion of the transaction amount comprises a percentage of the transaction amount. In some embodiments, the event is expiration of a time period for which the portion of the transaction amount is to be reserved.

After modifying the intercepted transaction into multiple money movements, processing logic sends the intercepted transaction with its multiple money movements to the book keeping system of a commerce platform (processing block 1605). In some embodiments, processing logic sends the intercepted transaction as part of a policy evaluation process. In some embodiments, processing logic sends the intercepted transaction with its multiple money movements to the book keeping system using one or more write operations.

Under direction of the book keeping system, processing logic stores funds associated with the portion of the transaction amount designated to be held in reserve in a reserve balance separate from reserve balances associated with other transactions of the plurality of transactions (processing logic 1606). In some embodiments, the book keeping system stores the funds or has access to the funds for purposes of transferring the funds.

Subsequently, processing logic determines the event has occurred for the intercepted transaction that had a portion of its transaction amount reserved (processing block 1607) and determines if funds of the other transactions are released also based on the event (processing block 1608). In some embodiments, if occurrence of the event triggers multiple reserve balances to be released, processing logic determines that the funds representing the portion of the transaction amount held in the reserved balance for the intercepted transactions should be released and transmitted based on an order with the release and transmission of funds of the other transactions determined to be released based on the same event (processing block 1609). In some embodiments, the order that the funds are released is a chronological order. For example, if funds of multiple reserve balances are released based on the same release event, then the funds of these multiple reserve balances are released occurring to the dates of their associated transactions from oldest to newest. Note that other ordering schemes can be used.

Thereafter, processing logic sends instructions to release and transfer the funds related to the portion of transaction amount reserved in the reserved balance (processing block 1610). In some embodiments, the funds are released in order with the release of funds of other reserved balances if other reserved balances are released based on the occurrence of the same event.

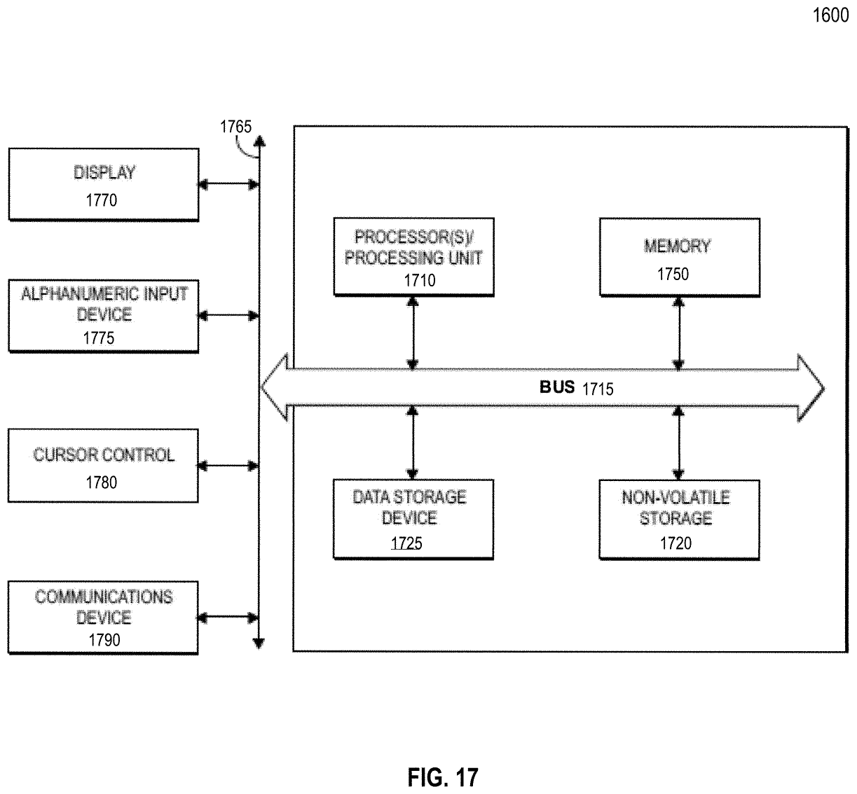

FIG. 17 is one embodiment of a computer system that may be used to support the systems and operations discussed herein. It will be apparent to those of ordinary skill in the art, however, that other alternative systems of various system architectures may also be used.

The data processing system illustrated in FIG. 17 includes a bus or other internal communication means 1715 for communicating information, and a processor(s) 1710 coupled to the bus 1715 for processing information. The system further comprises a random-access memory (RAM) or other volatile storage device 1750 (referred to as memory), coupled to bus 1715 for storing information and instructions to be executed by processor 1710. Main memory 1750 also may be used for storing temporary variables or other intermediate information during execution of instructions by processor(s) 1710. The system also comprises a read only memory (ROM) and/or static storage device 1720 coupled to bus 1715 for storing static information and instructions for processor 1710, and a data storage device 1725 such as a magnetic disk or optical disk and its corresponding disk drive. Data storage device 1725 is coupled to bus 1715 for storing information and instructions.

The system may further be coupled to a display device 1770, such as a light emitting diode (LED) display or a liquid crystal display (LCD) coupled to bus 1715 through bus 1765 for displaying information to a computer user. An alphanumeric input device 1775, including alphanumeric and other keys, may also be coupled to bus 1715 through bus 1765 for communicating information and command selections to processor 1710. An additional user input device is cursor control device 1780, such as a touchpad, mouse, a trackball, stylus, or cursor direction keys coupled to bus 1715 through bus 1765 for communicating direction information and command selections to processor 1710, and for controlling cursor movement on display device 1770.

Another device, which may optionally be coupled to computer system 1700, is a communication device 1790 for accessing other nodes of a distributed system via a network. The communication device 1790 may include any of a number of commercially available networking peripheral devices such as those used for coupling to an Ethernet, token ring, Internet, or wide area network. The communication device 1790 may further be a null-modem connection, or any other mechanism that provides connectivity between the computer system 1700 and the outside world. Note that any or all of the components of this system illustrated in FIG. 17 and associated hardware may be used in various embodiments as discussed herein.

In one embodiment, processor(s) 1710 executes instructions for, or to cause, intercepting transactions received via network communications, where each transaction of the plurality of transactions specifies a money movement request and is destined for a book keeping system of a commerce platform. Other operations include, for each intercepted transaction as part of performing a policy evaluation process, determining, if a fund flow transformation rule applies to each intercepted transaction based on attributes associated with each intercepted transaction, modifying at least one intercepted transaction by changing the money movement (e.g., into multiple money movements with at least one to reserve a portion of the transaction amount as a risk reserve, etc.) according to the fund flow transformation rule in response to determining a fund flow transformation rule applies to the at least one intercepted transaction, and thereafter sending each intercepted transaction, including those intercepted transactions with modified money movements, to the book keeping system of a commerce platform. In one embodiment, processor(s) 1710 executes instructions for, or to cause, handling reserve balances, including when events associated with the reserve balances occur. It will be appreciated by those of ordinary skill in the art that any configuration of the system may be used for various purposes according to the particular implementation. The control logic or software implementing the described embodiments can be stored in main memory 1750, mass storage device 1725, or other storage medium locally or remotely accessible to processor 1710.

It will be apparent to those of ordinary skill in the art that the system, method, and process described herein can be implemented as software stored in main memory 1750 or read only memory 1720 and executed by processor 1710. This control logic or software may also be resident on an article of manufacture comprising a computer readable medium having computer readable program code embodied therein and being readable by the mass storage device 1725 and for causing the processor 1710 to operate in accordance with the methods and teachings herein.

The embodiments discussed herein may also be embodied in a handheld or portable device containing a subset of the computer hardware components described above. For example, the handheld device may be configured to contain only the bus 1765, the processor 1710, and memory 1750 and/or 1725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1710, a data storage device 1725, a bus 1715, and memory 1750, and only rudimentary communications mechanisms, such as a small touch-screen that permits the user to communicate in a basic manner with the device. In general, the more special-purpose the device is, the fewer of the elements need to be present for the device to function.

There are a number of example embodiments described herein.

Example 1 is a method comprising intercepting a plurality of transactions received via network communications, each transaction of the plurality of transactions specifying a money movement and having a book keeping system of a commerce platform as a destination; and for each intercepted transaction, performing a policy evaluation process. In some embodiments, performing the policy evaluation process includes determining if a fund flow transformation rule applies to said each intercepted transaction based on attributes associated with said each intercepted transaction, in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and sending said each intercepted transaction, including the at least one intercepted transaction with the plurality of money movements, to the book keeping system of a commerce platform.

Example 2 is the method of example 1 that may optionally include determining that the at least one intercepted transaction is subject to a plan to reserve funds associated with the at least one intercepted transaction based on one or more of the attributes, and wherein determining if a fund flow transformation rule applies to the at least one intercepted transaction is based on determining that the at least one intercepted transaction is subject to the plan to reserve funds.

Example 3 is the method of example 1 that may optionally that the attributes include one or more of an amount associated with the money movement of a transaction, a purpose of the money movement, a party associated with a transaction.

Example 4 is the method of example 1 that may optionally that the portion of the transaction amount is reserved to account for risk associated with the at least one intercepted transaction being completed.

Example 5 is the method of example 1 that may optionally that the portion of the transaction amount comprises a percentage of the transaction amount.

Example 6 is the method of example 1 that may optionally that the event is expiration of a time period for which the portion of the transaction amount is to be reserved.

Example 7 is the method of example 1 that may optionally determining the event for the at least one intercepted transaction has occurred and releasing and transmitting funds associated with the portion of the transaction amount, in response to determining the event for the at least one intercepted transaction has occurred.

Example 8 is the method of example 7 that may optionally storing funds associated with the portion of the transaction amount in a reserve balance separate from reserve balances associated with other transactions of the plurality of transactions and determining if funds of the other transactions are released also based on the event, and wherein releasing and transmitting funds associated with the portion of the transaction amount for the at least one intercepted transaction is performed based on an order with the release and transmission of funds of the other transactions determined to be released based on the event.

Example 9 is the method of example 1 that may optionally tagging the one money movement with a tag to indicate the portion of the transaction amount is a reserve, where the tag comprises a qualitative representation of a reserve balance having the portion of the transaction amount associated with the at least one intercepted transaction, and persisting the tag in the book keeping system.

Example 10 is the method of example 1 that may optionally that modifying the at least one intercepted transaction is based on an invariant.

Example 11 is the method of example 1 that may optionally that the policy evaluation process comprises: analyzing a graph representing the money movement, and further wherein changing the money movement according to the fund flow transformation rule comprises mutating the graph based on the fund flow transformation rule; and after mutating the graph, determining which balances to use to complete the money movement of the at least one intercepted transaction according to the mutated graph and an ordering in which the balances are applied.

Example 12 is a system comprising: a memory to store instructions; and one or more processors coupled to the memory to execute the stored instructions to run a policy engine. In some embodiments, one or more processors run the policy engine by: for each transaction of a plurality of transactions in a commerce platform, where said each transaction specifies a money movement to be made by a payment processor of a commerce platform, intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction, in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and sending said each intercepted transaction, including the at least one intercepted transaction with the plurality of money movements, to the book keeping system of a commerce platform.

Example 13 is the system of example 12 that may optionally that the policy engine is operable to determine that the at least one intercepted transaction is subject to a plan to reserve funds associated with the at least one intercepted transaction based on one or more of the attributes, and wherein the policy engine determines if a fund flow transformation rule applies to the at least one intercepted transaction is based on determining that the at least one intercepted transaction is subject to the plan to reserve funds.

Example 14 is the system of example 13 that may optionally that in the attributes include one or more of an amount associated with the money movement of a transaction, a purpose of the money movement, a party associated with a transaction.

Example 15 is the system of example 12 that may optionally that the portion of the transaction amount is reserved to account for risk associated with the at least one intercepted transaction being completed.

Example 16 is the system of example 12 that may optionally that the event is expiration of a time period for which the portion of the transaction amount is to be reserved.

Example 17 is the system of example 12 that may optionally that the policy engine is operable to: determine the event for the at least one intercepted transaction has occurred; and release and transmit funds associated with the portion of the transaction amount, in response to determining the event for the at least one intercepted transaction has occurred.

Example 18 is the system of example 17 that may optionally that the policy engine is operable to: store funds associated with the portion of the transaction amount in a reserve balance separate from reserve balances associated with other transactions of the plurality of transactions; and determine if funds of the other transactions are released also based on the event, and wherein the policy engine releases and transmits funds associated with the portion of the transaction amount for the at least one intercepted transaction based on an order with the release and transmission of funds of the other transactions determined to be released based on the event.

Example 19 is one or more non-transitory computer readable storage media having instructions stored thereupon which, when executed by a system having at least a processor and a memory therein, cause the system to perform operations comprising: intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction, in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and sending said each intercepted transaction, including the at least one intercepted transaction with the plurality of money movements, to the book keeping system of a commerce platform.

Example 20 is the one or more non-transitory computer readable storage media of example 19 that may optionally that the operations further comprise determining that the at least one intercepted transaction is subject to a plan to reserve funds associated with the at least one intercepted transaction based on one or more of the attributes, and wherein determining if a fund flow transformation rule applies to the at least one intercepted transaction is based on determining that the at least one intercepted transaction is subject to the plan to reserve funds.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

We claim:

1. A method comprising:
intercepting a plurality of transactions received via network communications, each transaction of the plurality of transactions specifying a money movement and having a book keeping system of a commerce platform as a destination; and
for each intercepted transaction, performing a policy evaluation process that includes
determining if a fund flow transformation rule applies to said each intercepted transaction based on attributes associated with said each intercepted transaction,
in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and
sending said each intercepted transaction, including the at least one intercepted transaction with the plurality of money movements, to the book keeping system of a commerce platform.

2. The method of claim 1 further comprising determining that the at least one intercepted transaction is subject to a plan to reserve funds associated with the at least one intercepted transaction based on one or more of the attributes, and wherein determining if a fund flow transformation rule applies to the at least one intercepted transaction is based on determining that the at least one intercepted transaction is subject to the plan to reserve funds.

3. The method of claim 2 wherein the attributes include one or more of an amount associated with the money movement of a transaction, a purpose of the money movement, a party associated with a transaction.

4. The method of claim 1 wherein the portion of the transaction amount is reserved to account for risk associated with the at least one intercepted transaction being completed.

5. The method of claim 1 wherein the portion of the transaction amount comprises a percentage of the transaction amount.

6. The method of claim 1 wherein the event is expiration of a time period for which the portion of the transaction amount is to be reserved.

7. The method of claim 1 further comprising:
determining the event for the at least one intercepted transaction has occurred; and
releasing and transmitting funds associated with the portion of the transaction amount, in response to determining the event for the at least one intercepted transaction has occurred.

8. The method of claim 7 further comprising:
storing funds associated with the portion of the transaction amount in a reserve balance separate from reserve balances associated with other transactions of the plurality of transactions; and
determining if funds of the other transactions are released also based on the event, and wherein releasing and transmitting funds associated with the portion of the transaction amount for the at least one intercepted transaction is performed based on an order with the release and transmission of funds of the other transactions determined to be released based on the event.

9. The method of claim 1 further comprising:
tagging the one money movement with a tag to indicate the portion of the transaction amount is a reserve, where the tag comprises a qualitative representation of a reserve balance having the portion of the transaction amount associated with the at least one intercepted transaction; and
persisting the tag in the book keeping system.

10. The method of claim 1 wherein modifying the at least one intercepted transaction is based on an invariant.

11. The method of claim 1 wherein the policy evaluation process comprises:
analyzing a graph representing the money movement, and further wherein changing the money movement according to the fund flow transformation rule comprises mutating the graph based on the fund flow transformation rule; and
after mutating the graph, determining which balances to use to complete the money movement of the at least one intercepted transaction according to the mutated graph and an ordering in which the balances are applied.

12. A system comprising:
a memory to store instructions; and
one or more processors coupled to the memory to execute the stored instructions to run a policy engine to:
for each transaction of a plurality of transactions in a commerce platform, where said each transaction specifies a money movement to be made by a payment processor of a commerce platform,
intercepting a plurality of transactions received via network communications, each transaction of the plurality of transactions specifying a money movement and having a book keeping system of a commerce platform as a destination; and
for each intercepted transaction, performing a policy evaluation process that includes
determining if a fund flow transformation rule applies to said each intercepted transaction based on attributes associated with said each intercepted transaction,
in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and
sending said each intercepted transaction, including the at least one intercepted transaction with the plurality of money movements, to the book keeping system of a commerce platform.

13. The system of claim 12 wherein the policy engine is operable to determine that the at least one intercepted transaction is subject to a plan to reserve funds associated with the at least one intercepted transaction based on one or more of the attributes, and wherein the policy engine determines if a fund flow transformation rule applies to the at least one intercepted transaction is based on determining that the at least one intercepted transaction is subject to the plan to reserve funds.

14. The system of claim 13 wherein the attributes include one or more of an amount associated with the money movement of a transaction, a purpose of the money movement, a party associated with a transaction.

15. The system of claim 12 wherein the portion of the transaction amount is reserved to account for risk associated with the at least one intercepted transaction being completed.

16. The system of claim 12 wherein the event is expiration of a time period for which the portion of the transaction amount is to be reserved.

17. The system of claim 12 wherein the policy engine is operable to:
determine the event for the at least one intercepted transaction has occurred; and
release and transmit funds associated with the portion of the transaction amount, in response to determining the event for the at least one intercepted transaction has occurred.

18. The system of claim 17 wherein the policy engine is operable to:
store funds associated with the portion of the transaction amount in a reserve balance separate from reserve balances associated with other transactions of the plurality of transactions; and
determine if funds of the other transactions are released also based on the event, and wherein the policy engine releases and transmits funds associated with the portion of the transaction amount for the at least one intercepted transaction based on an order with the release and transmission of funds of the other transactions determined to be released based on the event.

19. One or more non-transitory computer readable storage media having instructions stored thereupon which, when executed by a system having at least a processor and a memory therein, cause the system to perform operations comprising:
intercepting a plurality of transactions received via network communications, each transaction of the plurality of transactions specifying a money movement and having a book keeping system of a commerce platform as a destination; and
for each intercepted transaction, performing a policy evaluation process that includes
determining if a fund flow transformation rule applies to said each intercepted transaction based on attributes associated with said each intercepted transaction,
in response to determining a fund flow transformation rule applies, modifying at least one intercepted transaction by changing the money movement according to the fund flow transformation rule into a plurality of money movements with specified balances to complete each money movement of the plurality of money movements, one of the plurality of money movements to reserve a portion of a transaction amount of the at least one intercepted transaction to a reserve balance for payout after occurrence of an event, and
sending said each intercepted transaction, including the at least one intercepted transaction with the plurality of money movements, to the book keeping system of a commerce platform.

20. The one or more non-transitory computer readable storage media of claim 19 wherein the operations further comprise determining that the at least one intercepted transaction is subject to a plan to reserve funds associated with the at least one intercepted transaction based on one or more of the attributes, and wherein determining if a fund flow transformation rule applies to the at least one intercepted transaction is based on determining that the at least one intercepted transaction is subject to the plan to reserve funds.
